(19) United States
(12) Patent Application Publication
(10) Pub. No.: US 2020/0043072 A1
(43) Pub. Date: Feb. 6, 2020

(54) SYSTEMS AND METHODS FOR AN ENTERPRISE PRICING SOLUTION

(71) Applicants: Hongmin Li, Tempe, AZ (US); Scott Webster, Tempe, AZ (US)

(72) Inventors: Hongmin Li, Tempe, AZ (US); Scott Webster, Tempe, AZ (US)

(73) Assignee: Arizona Board of Regents on Behalf of Arizona State University, Tempe, AZ (US)

(21) Appl. No.: 16/530,715

(22) Filed: Aug. 2, 2019

Related U.S. Application Data
(60) Provisional application No. 62/713,784, filed on Aug. 2, 2018.

(51) Int. Cl. G06Q 30/06

(52) U.S. Cl. CPC G06Q 30/0625

(57) ABSTRACT

Embodiments of a system and method for an enterprise product line design and pricing solution are disclosed.

### CROSS REFERENCE TO RELATED APPLICATIONS

This is a U.S. non-provisional patent application that claims benefit to U.S. provisional patent application Ser. No. 62/713,784 filed on Aug. 2, 2018, which is incorporated by reference in its entirety.

### FIELD

The present disclosure generally relates to an enterprise pricing solution, and in particular to systems and methods for a computer-implemented enterprise pricing solution to address the technical challenge of designing and computing pricing for complex product lines.

### BACKGROUND

Firms frequently introduce new products and retire old products to renew customers' interests in purchasing and consuming new products. For example, restaurants regularly add new items to its menu to spur new interests. Hotels introduce new room choices (e.g., free breakfast combo, executive package, and so on) from time to time to attract more customers. Manufacturers of home appliances periodically launch new models with improved features and efficiency driven by new trends in customer preference and life style. This phenomenon is even more pronounced in the high-tech industry due to a faster industry clockspeed. At Intel, for example, new microprocessor products are released on a quarterly basis. Such a product cadence leads to constantly evolving product lines and, at each change epoch, a firm has to determine what products to add to an existing product line and at what price points. That is, given the attributes and prices of the existing products, the firm optimizes the attributes and/or prices of the new products to maximize the total profit from the product line. Such business decisions are plagued by multiple complications. Higher attribute values and lower prices increase product appeal and attract more customers, but at a cost; attributes are costly and lower prices decrease unit revenue, both of which contribute to lower margins. In addition, the attractiveness of new products affects the market share of existing products and may cannibalize the profit of existing products. Thus, the firm needs to strike a balance between these competing forces.

This decision problem arises in a variety of industries but the nature of the problem is similar across industries. Consider a resort hotel that is adding new room choices to its existing offerings. Management would like to offer value packages that include basic room service plus resort credit to be used for ancillary services such as restaurants, gift shop, spa and entertainment. Table 1 provides information on existing products and a plausible set of new product offerings. The hotel's decision problem is to set the proper resort credit level and/or price for each new offer.

TABLE 1
Room Offerings at a Resort Hotel.

| | | Resort | | | | Resort | |
|---|---|---|---|---|---|---|---|
| Existing | Room | Credit | Price | New | Room | Credit | Price |
| 1 | One | 0 | 259 | 4 | One | 50 | 289 |
| | King | | | | King | | |
| 2 | Two | 0 | 299 | 5 | Two | 80 | 359 |
| | Queen | | | | Queen | | |
| 3 | King | 0 | 359 | 6 | King | 100 | 429 |
| | Suite | | | | Suite | | |

In another example, a smart phone manufacturer introduces a new model (M2) of phones to its product line, which will be sold concurrently with an existing phone model (M1). The manufacturer offers several storage-size variations of each model and needs to determine the storage size and/or price of each variation of the new model (Table 2).

TABLE 2
Existing and New Phone Models for a Smartphone Manufacturer

| Existing | Model | Storage | Price | New | Model | Storage | Price |
|---|---|---|---|---|---|---|---|
| 1 | M1 | 16 | 149 | 4 | M2 | 64 | 299 |
| 2 | M1 | 32 | 199 | 5 | M2 | 128 | 349 |
| 3 | M1 | 64 | 269 | 6 | M2 | 256 | 499 |

In both examples, the attribute to be optimized is a dimension that vertically differentiates the products and the firm optimizes the new products in the presence of existing products.

It is with these observations in mind, among others, that various aspects of the present disclosure were conceived and developed.

### BRIEF DESCRIPTION OF THE DRAWINGS

FIGS. 1A and 2B are graphical representations showing optimal attribute values versus b and β;

FIGS. 2A and 2B are other graphical representations showing optimal attribute values versus b and β;

FIG. 3 is an example schematic diagram of a computing system that may implement various methodologies of systems and methods for an enterprise pricing solution; and

FIG. 4 is a simplified block diagram of a computing system and/or network related to the computing device of FIG. 3 for implementing aspects of the functionality described herein.

Corresponding reference characters indicate corresponding elements among the view of the drawings. The headings used in the figures do not limit the scope of the claims.

### DETAILED DESCRIPTION

Various embodiments of a computer-implemented enterprise pricing solution that outputs a pricing value defining a solution for companies facing the challenge of designing complex product lines and computing optimized product line prices and attributes in an evolving product line are disclosed.

### Introduction

In the present disclosure, the attribute and price decisions for products with a vertically-differentiated attribute are disclosed. The attribute in some specific cases may be the quality of a product. Specifically, three variations of the problem are considered that are relevant in practice. In variation (i), the attribute values of all products are given and the firm optimizes the prices of the new products. This often arises when the attributes are pre-determined during the design and engineering stage and prices are decided close to product launch. In variation (ii), the prices of the new products are exogenous and the firm optimizes the product attributes. This is relevant when the firm follows pre-determined price points either due to convention or customer expectation. For example, it is a common practice at Intel to offer certain products at fixed price points: between March 2008 and August 2009, Intel repeatedly introduced its top product in the Core 2 family at the $530 price point. In variation (iii), the firm optimizes both price and attribute of the new products. The joint decision on prices and attributes typically occurs during strategic planning when a firm plans the next generation of product offerings. In practice, variations (i)-(iii) may be adopted by the same firm for different decision scopes and contexts. For instance, a firm may solve a variation (iii) problem during strategic planning but may re-optimize prices later by solving a variation (i) problem as a tactical adjustment. These decisions are considered when a firm adds to an existing product line but we note that the “clean-slate” version of the problem, i.e., when the firm can decide prices and/or attributes of all products to be offered, is a special case of the model in the present disclosure. This includes the case where the firm is starting a new product line, as well as the case in which the firm decides to re-optimize the prices and/or attributes of the existing products along with the new products.

Demand is modeled using a widely-adopted choice model for customers facing multiple product options—the multinomial logit (MNL) model. A new feature we include in the MNL model is the interaction between product attribute and product price, which allows the marginal utility of the attribute value to depend on the price level of the product, and likewise, marginal utility of price to depend on the attribute value of the product. This captures the commonly observed phenomenon that customers are less sensitive to price changes in high-quality product than low-quality product. It will be shown that this interaction rationalizes the matching of high markup with high quality which supplements the equal-markup pricing result in the literature. More significantly, it has important implications for decisions involving product attribute. It is further shown that the sequence of optimal attribute values among the newly offered products match the sequence of prices, controlling for other parameters; this holds in both attribute optimization and joint optimization. Analysis indicates that the interaction term plays a central role in justifying differentiated offering of new products. With the interaction effect of attribute and price, the optimal attribute and markup vary across products even under identical price sensitivity and cost function, which is a commonly-adopted strategy that can now be quantified and optimized with the model developed in this disclosure.

The ease of use and interpretation of the model makes the interaction term a simple but powerful tool for incorporating the moderating effect of price and quality on how they each affect customer utility or demand. This addition is built upon and the interaction term is adopted in the MNL model in a normative decision setting. This is the first application of this modification to a firm's product line decision under MNL demand. This interaction rationalizes the matching of high markup with high quality which supplements the equal-markup pricing result in the literature. The equal-markup result derives from the orthogonality of price and quality in their effect on customer utility and is not always consistent with observations in practice. The practice of charging higher markups for high quality is ubiquitous in today's market as well. For example, Apple currently sells two models of iPhone 7 at $549 and $649 for 32 GB and 128 GB capacity respectively, while the two models of iPhone 8 with 64 GB and 256 GB capacity are selling for $699 and $849 respectively (Apple Corporation Website, 2018b). Intel has a long history of selling its top-bin products (those with higher speed performance) at a much higher margin than the lower-bin products (Intel Corporation Website, 2018). Therefore, the result presented in the present disclosure is a more realistic characterization of the pricing decision. More significantly, it has important implications for decisions involving product quality. It is show that the sequence of optimal quality values among the newly offered products matches the sequence of prices, controlling for other parameters. The analysis described herein indicates that the interaction term plays a central role in justifying differentiated offering of new products. With the interaction effect of price and quality, the optimal quality and markup vary across products even under identical price sensitivity and cost function.

The theoretical contributions are fourfold: First, it is the first solution to solve joint pricing and attribute decisions under the MNL model allowing continuous attribute values. Existing literature that addresses joint pricing and attribute decisions examines a given assortment of products, i.e., the attribute values are a finite set of pre-selected discrete values and thus the insights are limited to assortment selection. The present disclosure, in contrast, yields strategic insights on how firm should design its product line and optimally set product attribute values on a continuum in conjunction with prices, providing decision support with a new dimension. Concavity of the profit functions is established under separate price and attribute optimizations and with considerations of existing products in the product line and we identify a sufficient condition for unique optimal solution for the joint price-attribute optimization. Second, the optimal prices and attributes are characterized and efficient algorithms developed for each problem variation. Third, the present disclosure is the first to include price-quality interaction in the optimization which helps reconcile the divergence of existing literature's equal-markup price prediction from empirical practices and uncovers new insights on product attribute decisions as the product line evolves. Lastly, the disclosed model extends to a multi-attribute setting for both attribute optimization and joint price-attribute optimization.

### Model

A customer makes a selection of one of n product choices and a no-purchase alternative. The product purchase probabilities are given by the MNL model. Let the utility of product i, i=1, 2, . . . , n be

uᵢ=xᵢ−bᵢpᵢ+βᵢxᵢpᵢ+aᵢ+ϵᵢ

where xᵢ is the attribute value, pᵢ is the price of product i, aᵢ represents an observable utility term that is independent of xᵢ and pᵢ, and ϵᵢ is a random noise term which is a Gumbel random variable that represents unobserved utility. aᵢ refers to utility from attributes that are exogenously determined and orthogonal to the attribute xᵢ. For example, for hotel rooms, aᵢ may capture utility associated with the type of room such as King, Queen and Suite, whereas xᵢ reflects utility of ancillary services such as packages that include resort credit, event activities and meals. For smart phone products, aᵢ may be associated with the model type (e.g., iPhone 7, iPhone 7plus), and xᵢ may be associated with the storage size (e.g., 64 GB, 256 GB), similar to the example in Table 2. That is, the quality measure x is a linear utility scale transformed from the nominal scale of a certain attributes such as storage size or resort credit. Without loss of generality, it can be assumed that xᵢ ∈[0, xᵢ⁺] where xᵢ=0 and xᵢ=xᵢ⁺ align with the lowest and highest possible quality level respectively. For example, the quality scale for smart phones could be the logarithm transformation of the nominal storage size. Then, adjusting for a minimum required size of 16 GB (i.e., align xₛ=0 with 16 GB), nominal values of 64 GB, 128 GB and 256 GB correspond to x values of 0.6, 0.9, and 1.2 respectively, while the maximum xᵢ⁺ may correspond to the scaled value of some practical upper limit of storage size. Parameters bᵢ>0 and βᵢ≥0 are the coefficients for price sensitivity where bᵢ is quality-independent sensitivity and βᵢ is the coefficient for the interaction term and captures the heterogeneity in customer sensitivity towards the product price at different quality levels. It is assumed that bᵢ−βᵢxᵢ is always positive, i.e., customers always experience a disutility toward higher prices.

Interaction terms in regression models are used to capture how the marginal effect of one explanatory variable on the dependent variable is modified by another explanatory variable and are prevalent in statistics and econometric applications. An interaction term is typically modeled as the product of two variables in the regression equation

Y=β₀+β₁X₁+β₂X₂+β₁₂X₁X₂+ϵ.

The same form of interaction terms is also commonly adopted in logit and probit models. The interaction term in the utility function of the logit model allows the marginal utility of attribute x to depend on price p and equivalently, the marginal disutility of price p to depend on x. Specifically, rewrite the utility function in two alternative forms.

uᵢ=xᵢ−(bᵢ−βᵢxᵢ)pᵢ+aᵢ+ϵᵢ and (1)

uᵢ=(1+βᵢpᵢ)xᵢ−bᵢpᵢ+aᵢ+ϵᵢ. (2)

The marginal disutility of pᵢ is given by (bᵢ−βᵢxᵢ) which decreases with attribute; the marginal utility of xᵢ is (1+βᵢpᵢ) which increases with price. As discussed previously, this in effect models the empirical observation that customers are less sensitive to price change at high quality, or equivalently, customers are more sensitive to quality change at high price (i.e.,

$$- \frac{\partial }{\partial {x}_{i}} ( \frac{\partial ( - {u}_{i} )}{\partial {p}_{i}} ) = \frac{\partial }{\partial p} ( \frac{\partial {u}_{i}}{\partial {x}_{i}} ) \geq 0 where \frac{\partial ( - ui )}{\partial {p}_{i}}$$

is the marginal disutility of price).

Let J be the set of existing products and l be the set of new products. Assume the no-purchase option has a utility of zero. For product j∈J, its price, attribute, and cost values are fixed at p̅ⱼ, x̅ⱼ, and c̅ⱼ respectively. Let x=(xᵢ)_{i∈l} be the vector of attribute values of the new products. For the ease of notation, we also define ūⱼ=x̅ⱼ−bⱼp̅ⱼ+βⱼx̅ⱼp̅ⱼ+ⱼ, m̅ⱼ=p̅ⱼ−c̅ⱼ and

$${\overline{π}}_{J} = \frac{{\sum }_{j ∈ J} {\overline{m}}_{j} {e}^{{\overline{u}}_{j}}}{1 + {\sum }_{j ∈ J} {e}^{u} j} .$$

Note that π̅_{J} is the firm's expected profit prior to the addition of the new products.

The purchase probability of a new product l∈l is

$${q}_{i} = \frac{{e}^{{x}_{i} - {b}_{i} {p}_{i} + {β}_{i} {x}_{i} {p}_{i} + {α}_{i}}}{1 + {\sum }_{j ∈ J} {e}^{\overline{u} j} + {\sum }_{{i}^{′} ∈ I} {e}^{{x}_{{i}^{′}} - {b}_{{i}^{′}} {p}_{{i}^{′}} + {β}_{{i}^{′}} {x}_{{i}^{′}} {p}_{{i}^{′}} + {a}_{{i}^{′}}}} , \qquad ( 3 )$$

the purchase probability of an existing product j∈J is

$${q}_{j} = \frac{{e}^{{\overline{u}}_{{j}^{′}}}}{1 + {\sum }_{{j}^{′} ∈ J} {e}^{{\overline{u}}_{{j}^{′}}} + {\sum }_{i ∈ I} {e}^{{x}_{{i}^{′}} - {b}_{i} {p}_{i} + {β}_{i} {x}_{i} {p}_{i} + {a}_{i}}} and \\ {q}_{0} = \frac{1}{1 + {\sum }_{j ∈ J} {e}^{{\overline{u}}_{j}} + {\sum }_{i ∈ I} {e}^{{x}_{i} - {b}_{i} {p}_{i} + {β}_{i} {x}_{i} {p}_{i} + {a}_{i}}} \qquad ( 4 )$$

is the no-purchase probability. Therefore,

qᵢ=q₀e^{x}^{ᵢ}^{-b}^{ᵢ}^{p}^{ᵢ}^{+β}^{ᵢ}^{x}^{ᵢ}^{p}^{ᵢ}^{+a}^{ᵢ} and (5)

qⱼ=q₀e^{ū}^{ⱼ}. (6)

### Price Optimization

Price optimization arises when the firm sets prices of the new products to maximize the total profit from the product line. For instance, in Table 1, the resort hotel decides the prices of the new room offers based on the information of existing room offers and the planned service packages for each room type in the new offers; similarly in Table 2, the smartphone manufacturer decides the prices of the new phones given all other information. The present disclosure provides solutions to this problem through two features: (1) consideration of existing products in the product line, and (2) consideration of quality-price interaction. In the presence of existing products, the pricing decision of the new products affects not only the relative market share of the new products, but also those of the existing products. Hence, it does not merely imply an enlarged no-purchase utility with the additional constant term Σ_{j∈J}e^{ū}^{ⱼ} as equation (3) might have suggested. Incorporating the interaction of quality and price enables us to characterize how quality differences translate to price differences across products, thereby reconciling the counterintuitive equal-markup solution in the literature.

Let p=(pᵢ)_{j∈l} be the vector of prices of the new products. The firm's price optimization problem is

$${max}_{p} π ( p ) = {\sum }_{i ∈ I} ( {p}_{i} - {c}_{i} ) {q}_{i} ( p ) + {\sum }_{j ∈ J} {\overline{m}}_{j} {q}_{j} ( p ) ,$$

which is not a concave or a quasiconcave maximization even for the special case of J=∅ (Dong et al., 2009). Profit is rewritten as a function of choice probabilities of the new products, q=(qᵢ)_{i∈l}, and show that this function is concave. From (5) and (6),

$${p}_{i} = ( {\overline{x}}_{i} + {a}_{i} + log {q}_{0} - log {q}_{i} ) / ( {b}_{i} - {β}_{i} {\overline{x}}_{i} ) and \\ {q}_{0} = 1 - {\sum }_{i ∈ I} {q}_{i} - {\sum }_{j ∈ J} {q}_{j} = 1 - {\sum }_{i ∈ I} {q}_{i} - ( {\sum }_{j ∈ J} {e}^{{\overline{u}}_{j}} ) {q}_{0} , \qquad ( 7 )$$

the latter of which is equivalent to

$${q}_{0} = \frac{1 - {\sum }_{i ∈ I} {q}_{i}}{1 + {\sum }_{j ∈ J} {e}^{{\overline{u}}_{j}}} . \qquad ( 8 )$$

The price optimization problem can be restated as

$${max}_{q} \hat{π} ( q ) = {\sum }_{i ∈ I} ( {p}_{i} ( q ) - {c}_{i} ) {q}_{i} + {\sum }_{j ∈ J} {\overline{m}}_{j} {q}_{j} ( q ) , \\ where \\ {p}_{i} ( q ) = [ {\overline{x}}_{i} + {a}_{i} + log ( \frac{1 - {\sum }_{i ∈ I} {q}_{i}}{1 + {\sum }_{j ∈ J} {e}^{{\overline{u}}_{i}}} ) - log {q}_{i} ] / ( {b}_{i} - {β}_{i} {\overline{x}}_{i} ) and \\ {q}_{j} ( q ) = \frac{1 - {\sum }_{i ∈ I} {q}_{i}}{1 + {\sum }_{j ∈ J} {e}^{{\overline{u}}_{j}}} {e}^{{\overline{u}}_{j}} . \qquad ( 9 )$$

Theorem 1. \hat{π}(q) is concave in q.

The proof of Theorem 1 follows the logic presented in the proof of Theorem 3, and is omitted. Previous works have shown that the profit is concave in the choice probability vector for a clean-slate problem in which J=∅. Theorem 1 extends the state-of-art literature and establishes a unique optimal solution in the presence of existing products.

Theorem 2. The optimal prices of the new products and the firm's optimal total profit are

$${p}_{i}^{*} = {c}_{i} + \frac{1}{{b}_{i} - {β}_{i} {\overline{x}}_{i}} + θ \\ {π}^{*} = θ \qquad ( 10 )$$

where θ solves the single-variable equation

$$θ = {\overline{π}}_{j} + \frac{{\sum }_{i ∈ I} {e}^{{\overline{x}}_{i} + {a}_{i} - 1 - ( {b}_{i} - {β}_{i} {\overline{x}}_{i} ) ( {c}_{i} + θ )} / ( {b}_{i} - {β}_{i} {\overline{x}}_{i} )}{1 + {\sum }_{j ∈ J} {e}^{{\overline{u}}_{j}}} . \qquad ( 11 )$$

From Theorem 2, all else equal, the optimal markup is higher for higher-quality product, and for product with lower bᵢ and higher βᵢ values, as stated in the following corollary.

Corollary 1. At optimality, the following holds for

i, i′∈I, i≠i′: (i) let bᵢ=bₚ and βᵢ=βₚ.

Then, p*ᵢcᵢ>p*ₚ−cₚ if and only if x̅ᵢ>x̅ₚ. (ii) Let βᵢ=βₚ and x̅ᵢ=x̅ₚ. Then p*ᵢ−cᵢ>p*ₚ−cₚ if and only if bᵢ<bₚ. (iii) Let bᵢ=bₚ and x̅ᵢ=x̅ₚ. Then p*ᵢ−cᵢ>p*_{i′}−c_{i′} if and only if βᵢ>βₚ.

Hence, controlling other parameters, a hotel room with a higher resort credit package or a smartphone with larger storage size should command a higher markup than its peer products. The next corollary implies that the well-known equal mark-up property holds if βᵢ=0 and bᵢ=b for all l∈l.

Corollary 2. If bᵢ=b and βᵢ=0 for all i∈l, then the optimal prices become

$${p}_{i}^{*} = {c}_{i} + {\overline{π}}_{J} + \frac{1}{b} [ 1 + W ( \frac{{\sum }_{i ∈ I} {e}^{{\overline{x}}_{i} + {a}_{i} - {bc}_{i} - 1 - b {\overline{π}}_{j}}}{1 + {\sum }_{j ∈ J} {e}^{{\overline{u}}_{j}}} ) ]$$

where W(·) is the Lambert W function.

It should be remarked that, treating bᵢ−βᵢx̅ᵢ as the effective price sensitivity, the relationship in (10) reproduces the more general equal “adjusted mark-up” property identified previously, but specializes it in terms of quality-price interaction.

Theorem 2 also leads to the following bounds for π*.

### Corollary 3.

$${\overline{π}}_{J} \leq {π}^{*} \leq {\overline{π}}_{J} + \frac{{\sum }_{i ∈ I} {e}^{{\overline{x}}_{i} + {a}_{i} - 1 - ( {b}_{i} - {β}_{i} {\overline{x}}_{i} ) ( {c}_{i} + {\overline{π}}_{J} )} / ( {b}_{i} - {β}_{i} {\overline{x}}_{i} )}{1 + {\sum }_{j ∈ J} {e}^{{\overline{u}}_{j}}} .$$

These bounds, along with equation (11), lead to an efficient bisection search algorithm for solving the optimal profit and prices.

Algorithm 1. (Price Optimization)

$1. Let {θ}^{-} = {\overline{π}}_{J} and {θ}^{+} = {\overline{π}}_{J} + \frac{{\sum }_{i ∈ I} {e}^{{\overline{x}}_{i} + {a}_{i} - 1 - ( {b}_{i} - {β}_{i} {\overline{x}}_{i} ) + ( {c}_{i} + {\overline{π}}_{J} ) / ( {b}_{i} - {β}_{i} {\overline{x}}_{i} )}}{1 + {\sum }_{j ∈ J} {e}^{{\overline{u}}_{j}}} .$
2. Let θ = (θ⁻ + θ⁺)/2.
$3. Compute f = {\overline{π}}_{J} + \frac{{\sum }_{i ∈ I} {e}^{{x}_{i} + {a}_{i} - 1 - ( {b}_{i} - {β}_{i} {\overline{x}}_{i} ) + ( {c}_{i} + θ ) / ( {b}_{i} - {β}_{i} {\overline{x}}_{i} )}}{1 + {\sum }_{j ∈ J} {e}^{{\overline{u}}_{j}}} .$
4. If f > θ, let θ⁻ = θ; if f < θ, let θ⁺ = θ.
5. Repeat Steps 2-4 until f = θ.
6. Compute optimal prices according to equation (10).

### EXAMPLES

Consider a manufacturer with a product cost function c(a, x)=0.5a+x². Suppose the manufacturer currently offers three products with aⱼ, x̅ⱼ and p̅ⱼ values shown in Table 3. The manufacturer plans to add three new products, products 4-6, with attributes given in Table 3, while still keeping products 1-3 in its portfolio and maintaining their current prices. The price coefficients are bᵢ=bⱼ=1 and βᵢ=βⱼ=0.2 for all i∈l and j∈J. Algorithm 1 is applied to obtain the optimal prices for the new products. It was observed that the optimal markups vary across products despite that all products have the same b and β values. This is more in line with practice than the equal-markup solution.

TABLE 3
Price Optimization.

| Initial | | | | | New | | | | |
|---|---|---|---|---|---|---|---|---|---|
| Products | | | | | Products | | | | |
| (j ϵ J) | αⱼ | \tilde{x}ⱼ | \tilde{p}ⱼ | \tilde{m}ⱼ | (i ϵ I) | αᵢ | \tilde{x}ᵢ | pᵢ* | mᵢ* |
| 1 | 0.0 | 0.5 | 2 | 1.75 | 4 | 0.0 | 0.8 | 3.39 | 2.75 |
| 2 | 1.0 | 0.8 | 3 | 1.86 | 5 | 1.0 | 1.0 | 4.31 | 2.81 |
| 3 | 2.0 | 1.0 | 4 | 2.00 | 6 | 2.0 | 1.2 | 5.32 | 2.86 |

Table 4 presents a comparison of problem instances and sheds light on how optimal prices are affected by the magnitude of b, β and the quality of the new products. In these examples, the quality and prices for three existing products are {a}_{j∈J}=[0, 1, 2], {\ddot{x}}_{j∈J}=[0.5, 0.8, 1.0] and {\ddot{p}}_{j∈J}=[2, 3, 4]. The cost function is the same as in the example of Table 3. The comparison of instances 1-3 demonstrates the effect of the parameter b while the comparison of instances 2, 4 and 5 demonstrates the effect of the parameter β—the optimal prices decrease in b and increase in β. Instances 2, 6, and 7 suggest that higher quality levels lead to higher prices while instances 7-9 show that a larger quality gap between products (i.e., larger x̅ᵢ−x̅_{i′} value) results in a larger price gap (i.e., larger pᵢ⁺-pₚ⁺ value).

TABLE 4
Optical Quality Vary with Prices.

| | | | New Quality | | | Optimal Prices | | | |
|---|---|---|---|---|---|---|---|---|---|
| Instance | b | β | \tilde{x}₄ | \tilde{x}₅ | \tilde{x}₆ | p₄* | p₅* | p₆* | profit |
| 1 | 2.00 | 0.05 | 0.8 | 1.0 | 1.2 | 1.39 | 2.25 | 3.19 | 0.24 |
| 2 | 1.00 | 0.05 | 0.8 | 1.0 | 1.2 | 2.95 | 3.83 | 4.78 | 1.27 |
| 3 | 0.50 | 0.05 | 0.8 | 1.0 | 1.2 | 5.09 | 6.00 | 6.99 | 2.27 |
| 4 | 1.00 | 0.10 | 0.8 | 1.0 | 1.2 | 3.09 | 3.98 | 4.94 | 1.36 |
| 5 | 1.00 | 0.20 | 0.8 | 1.0 | 1.2 | 3.39 | 4.31 | 5.32 | 1.56 |
| 6 | 1.00 | 0.05 | 0.3 | 0.5 | 0.7 | 2.42 | 3.09 | 3.85 | 1.32 |
| 7 | 1.00 | 0.05 | 0.2 | 0.4 | 0.6 | 2.36 | 3.00 | 3.71 | 1.31 |
| 8 | 1.00 | 0.05 | 0.2 | 0.5 | 0.8 | 2.36 | 3.09 | 3.99 | 1.31 |
| 9 | 1.00 | 0.05 | 0.5 | 1.0 | 1.5 | 2.51 | 3.79 | 5.57 | 1.24 |

### Attribute Optimization

Next, the attribute optimization problem will be presented in which the firm optimizes the attribute values xᵢ of the new products i∈l while the attribute values of existing product j∈J are fixed at x̅ⱼ. Product prices are exogenously given, denoted by p̅ᵢ, i∈I∪J. For example, the resort hotel in Table 1 may create three new room offerings at the price levels $289, $359 and $429 respectively and wish to optimize the service package value for each new room offering. In the hotel example, aᵢ represents customers' utility for a particular room type (i.e., King, Queen or Suite) and xᵢ represents customers' utility for a particular service package (e.g., $50, $80, or $100 resort credit). In general, the value of aᵢ reflects the composite utility of all attributes of product i that are not part of the design decision (i.e., features of the product that are not to be changed), whereas xᵢ is the utility from the attribute to be optimized. The choice of attribute value affects product cost. Let cᵢ(xᵢ) be the unit cost of product i∈l at attribute value xᵢ, which is assumed to be nonnegative and strictly increasing. The product cost function may differ across products, reflecting differences in fixed and variable attributes, i.e., cᵢ(xᵢ)=c(aᵢ, xᵢ). For brevity, we denote the cost function with cᵢ(xᵢ) but we emphasize that it is also a function of aᵢ.

Let x=(xᵢ)_{i∈l} denote the vector of attribute values for the new products. The attribute optimization problem is

$${max}_{x} π ( x ) = {\sum }_{i ∈ I} ( {\overline{p}}_{i} - {c}_{i} ( {x}_{i} ) ) {q}_{i} ( x ) + {\sum }_{j ∈ J} {\overline{m}}_{j} {q}_{j} ( x )$$

where m̅ⱼ is the contribution margin of product j∈J.

Observe that setting xᵢ=bᵢ/βᵢ for all i∈l yields infinite optimal profit if cᵢ(bᵢ/βᵢ) is finite for all i∈l, i.e.,

$$π ( {( {b}_{i} / {β}_{i} )}_{i ∈ I} , P ) = {\sum }_{i ∈ I} ( {p}_{i} - {c}_{i} ( {b}_{i} / {β}_{i} ) ) ( \frac{{e}^{{b}_{i} / {β}_{i}}}{1 + {\sum }_{k ∈ I} {e}^{{b}_{k} / {β}_{k}} + {\sum }_{j ∈ J} {e}^{{\overline{u}}_{j}}} ) + {\sum }_{j ∈ J} {\overline{m}}_{j} ( \frac{{e}^{{\overline{u}}_{j}}}{1 + {\sum }_{k ∈ I} {e}^{{b}_{k} / {β}_{k}} + {\sum }_{j ∈ J} {e}^{{\overline{u}}_{j}}} )$$

which goes to infinity as p→∞. To avoid this pathological solution, we assume that the cost function becomes unbounded prior to x=min_{i∈l} bᵢ/βᵢ, i.e., technological constraints are such that it is impossible to produce a product with non-price attribute of x=min_{i∈l} bᵢ/βᵢ. We let x⁺<min_{i∈l} bᵢ/βᵢ denote the technological upper limit of quality, i.e.,

From (5),

$${x}_{i} = \frac{{b}_{i} {\overline{p}}_{i} + log {q}_{i} - log {q}_{0}}{1 + {β}_{i} {\overline{p}}_{i}} - {a}_{i} . \qquad ( 12 )$$

From (8), q₀ is a linear function of q. Substitute (6) and (12) into the total profit to obtain the total profit as a function of q.

$$\begin{matrix}\hat{π} ( q ) = {\sum }_{i ∈ I} ( {\overline{p}}_{i} - {c}_{i} ( \frac{{b}_{i} {\overline{p}}_{i} + log {q}_{i} - log {q}_{0} ( q )}{1 + {β}_{i} {\overline{p}}_{i}} ) - {a}_{i} ) {q}_{i} + ( {\sum }_{j ∈ J} {\overline{m}}_{j} {e}^{{\overline{u}}_{j}} ) {q}_{0} ( q ) \\ = {\sum }_{i ∈ I} {\overline{p}}_{i} {q}_{i} - {\sum }_{i ∈ I} {c}_{i} ( \frac{{b}_{i} {\overline{p}}_{i} + log {q}_{i} - log {q}_{0} ( q )}{1 + {β}_{i} {\overline{p}}_{i}} - {a}_{i} ) {q}_{i} + \\ ( {\sum }_{j ∈ J} {\overline{m}}_{j} {e}^{{\overline{u}}_{j}} ) {q}_{0} ( q ) .\end{matrix} \qquad ( 13 )$$

The first and third terms are both linear in q (see equation (8)), thus if the term

$${c}_{i} ( \frac{{b}_{i} {\overline{p}}_{i} + log {q}_{i} - log {q}_{0} ( q )}{1 + {β}_{i} {\overline{p}}_{i}} - {a}_{i} ) {q}_{i}$$

is convex in q, then the total profit is concave in q. To establish convexity of this cost term, we make use of Lemma 1 which is a generalization of Lemma 2.
Lemma 1. Let φ(z₁, z₂)=z₁f (k[log z₁-log(1−z₂)]+δ) where k>0 and δ are constants. Assume f′(·)+k f″(·)≥0. Then φ is jointly convex on [0,1]².
Assumption 1. The cost function cᵢ(xᵢ), i∈l is twice differentiable and satisfies

$${c}_{i}^{′} ( {x}_{i} ) + \frac{1}{1 + {β}_{i} {\overline{p}}_{i}} {c}_{i}^{″} ( {x}_{i} ) > 0 for all {x}_{i} \leq {x}_{i}^{+} . \qquad ( 14 )$$

Assumption 1 ensures that the cost function is well-behaved and is satisfied by any increasing and convex cost function.

Theorem 3. Suppose Assumption 1 holds. Then \hat{π}(q) is concave in q.

Since the total profit is concave in the choice probability vector q, the optimal solution is unique and can be derived from the first-order condition. Take the derivative of \hat{π}(q) with respect to qᵢ and set it to zero to obtain

$${\overline{p}}_{i} - {c}_{i} ( \frac{{b}_{i} {\overline{p}}_{i} + log {q}_{i} - log {q}_{0}}{1 + {β}_{i} {\overline{p}}_{i}} - {a}_{i} ) - \frac{1}{1 + {β}_{i} {\overline{p}}_{i}} {c}_{i}^{′} ( \frac{{b}_{i} {\overline{p}}_{i} + log {q}_{i} - log {q}_{0}}{1 + {β}_{i} {\overline{p}}_{i}} - {a}_{i} ) = \frac{{\sum }_{j ∈ J} {\overline{m}}_{j} {e}^{{\overline{u}}_{j}}}{1 + {\sum }_{j ∈ J} {e}^{{\overline{u}}_{j}}} + \frac{{\sum }_{{i}^{′} ∈ I} \frac{1}{1 + {β}_{{i}^{′}} {\overline{p}}_{{i}^{′}}} {q}_{i} {c}_{{i}^{′}}^{′} ( \frac{{b}_{{i}^{′}} {\overline{p}}_{{i}^{′}} + log {q}_{{i}^{′}} - log {q}_{0}}{1 + {β}_{{i}^{′}} {\overline{p}}_{{i}^{′}}} - {a}_{{i}^{′}} )}{1 - {\sum }_{{i}^{′} ∈ I} {q}_{{i}^{′}}} . \qquad ( 15 )$$

Note that the right side of (15) is independent of i. Substituting (3), (8) and (12), we can rewrite the first order condition as

$${\overline{p}}_{i} - {c}_{i} ( {x}_{i} ) - \frac{1}{1 + {β}_{i} {\overline{p}}_{i}} {c}_{i}^{′} ( {x}_{i} ) = \frac{{\sum }_{j ∈ J} {\overline{m}}_{j} {e}^{{\overline{u}}_{j}}}{1 + {\sum }_{j ∈ J} {e}^{{\overline{u}}_{j}}} + \frac{{\sum }_{{i}^{′} ∈ I} \frac{1}{1 + {β}_{{i}^{′}} {\overline{p}}_{{i}^{′}}} {e}^{{x}_{{i}^{′}} + {a}_{{i}^{′}} - {b}_{{i}^{′}} {\overline{p}}_{{i}^{′}} + {β}_{{i}^{′}} {x}_{{i}^{′}} {\overline{p}}_{{i}^{′}}} {c}_{{i}^{′}}^{′} ( {x}_{{i}^{′}} )}{1 + {\sum }_{j ∈ J} {e}^{{\overline{u}}_{j}}} . \qquad ( 16 )$$

For any given θ, let x(θ) denote the vector of attribute values that solves

$${\overline{p}}_{i} - {c}_{i} ( {x}_{i} ) - \frac{1}{1 + {β}_{i} {\overline{p}}_{i}} {c}_{i}^{′} ( {x}_{i} ) = θ , i ∈ I . \qquad ( 17 )$$

By Assumption 1, the left side of (17) decreases in xᵢ. Thus for any given θ, the solution of Equation (17) is unique and x(θ) is decreasing in θ.

Lemma 2: Suppose Assumption 1 holds. Then for any given θ, x (θ) is unique.

Therefore, we can compare the optimal attribute values across products utilizing equation (17).

Corollary 4. For any i, i′ ∈l and i≠i′,

let βᵢ=β_{i′} and cᵢ(·)=c_{i′}(·), then xᵢ^{k}>x_{i′}^{k} if and only if p̅ᵢ>p̅_{i′}. (i)

let p̅ᵢ=p̅_{i′} and cᵢ(·)=c_{i′}(·), then xᵢ^{k}>x_{i′}^{k} if and only if βᵢ>β_{i′}. (ii)

The sign of xᵢ^{k}−x_{i′}^{k} is independent of bᵢ and b_{i′} values. (iii)

Result (i) states that, all else equal, a higher-priced product should be matched with a higher attribute, which is consistent with observations in practice. Since a larger interaction coefficient βᵢ implies that customers are more sensitive to quality increment for this product, result (ii) is also expected. Result (iii) indicates that the magnitude of bᵢ does not affect how the optimal attribute values compare across products; this result draws an interesting contrast with the joint price and attribute optimization discussed later herein.

From Lemma 2, the total profit can be expressed as a function of θ:

$$\tilde{π} ( θ ) = {\sum }_{i ∈ I} ( {p}_{i} - {c}_{i} ( {x}_{i} ( θ ) ) ) {q}_{i} ( x ( θ ) ) + {\sum }_{j ∈ J} {\overline{m}}_{j} {q}_{j} ( x ( θ ) ) .$$

The next theorem shows that a fixed-point relationship holds at optimality.

Theorem 4. Let θ*=argmax_{θ}\tilde{π}(θ), Then ϑ satisfies \tilde{π}(θ)=θ and is the unique solution of the equation

$${θ}^{*} = \frac{{\sum }_{j ∈ J} {\overline{m}}_{j} {e}^{{\overline{u}}_{j}}}{1 + {\sum }_{j ∈ J} {e}^{{\overline{u}}_{j}}} + \frac{{\sum }_{i ∈ I} \frac{1}{1 + {β}_{i} {\overline{p}}_{i} } {e}^{{x}_{i} ( {θ}^{*} ) + {a}_{i} - {b}_{i} {\overline{p}}_{i} + {β}_{i} {x}_{i} ( {θ}^{*} ) {\overline{p}}_{i}} {c}_{i}^{′} ( {x}_{i} ( {θ}^{*} ) )}{1 + {\sum }_{j ∈ J} {e}^{{\overline{u}}_{j}}} . \qquad ( 18 )$$

Next, how to find the optimal solution will be considered. It can be shown that the right side of (18) decreases in θ* for cost functions satisfying (14) (see the proof of Theorem 4). The left side increases in θ*. Therefore, the above equation can be efficiently solved with a bisection search. From equations (17) and (18), and the fact that the right side of (18) is decreasing in θ*, θ* is bounded in the following interval.

### Corollary 5.

$${\overline{π}}_{J} \leq {θ}^{*} \leq min \{ \frac{{\sum }_{i ∈ I} \frac{1}{1 + {β}_{i} {p}_{i}} {e}^{{x}_{i} ( {\overline{π}}_{J} ) + {a}_{i} - {b}_{i} {\overline{p}}_{i} + {β}_{i} {x}_{i} ( {\overline{π}}_{J} ) {\overline{p}}_{i}} {c}_{i}^{′} ( {x}_{i} ( {\overline{π}}_{J} ) )}{1 + {\sum }_{j ∈ J} {e}^{{\overline{u}}_{j}}} , {min}_{i ∈ I} {\overline{p}}_{i} \} .$$

Therefore, for an interior solution θ* to exist, the following condition is needed.

Assumption 2. \ddot{π}_{J}<\ddot{p}ᵢ for all i∈l.

If Assumption 2 does not hold, then at least for some i (those with lowest price), the first-order derivative

$$\frac{\partial \hat{π}}{\partial {q}_{i}}$$

is always negative. Therefore, the product with the lowest price should have its quantity (and thus attribute) set to as low as possible. More generally, a sufficient condition for

$$\frac{\partial \hat{π} ( q )}{\partial {q}_{i}} < 0$$

for any q is pᵢ≤\ddot{π}_{J} which implies product i should not be included in the portfolio. This is consistent with the known result on assortment under MNL. Talluri and van Ryzin (2004) show that the optimal assortment is a revenue-ordered assortment consisting of products with the highest revenues. We remark that such a pre-optimization condition does not exist for the price optimization problem discussed herein, which is also consistent with the known result on joint price and assortment optimization under MNL that the optimal assortment is to include all products.

From (18) and Corollary 5, the following algorithm is derived for attribute optimization.

Algorithm 2. (Attribute Optimization)

```
$1. Let {θ}^{-} = {\overline{π}}_{J} and {θ}^{+} = min \{ \frac{{\sum }_{i ∈ I} \frac{1}{1 + {β}_{i} \overline{{p}_{i}}} {e}^{{x}_{i} ( {\overline{π}}_{J} ) + {a}_{i} - {b}_{i} {\overline{p}}_{i} + {β}_{i} {\overline{x}}_{i} ( {\overline{π}}_{J} ) {\overline{p}}_{{i}_{{c}_{i}^{′} ( {x}_{i} ( {\overline{π}}_{J} ) )}}}}{1 + {\sum }_{j ∈ J} {e}^{{\overline{u}}_{j}}} , {min}_{i ∈ I} {\overline{p}}_{i} \} .$
2. Let θ = (θ⁻ + θ⁺)/2.
3. Solve Equation (17) through the following bisection search to
obtain xᵢ(θ) for all i ∈ I:
  (a) Let y⁻ = 0 and y⁺ = xᵢ⁺.
  (b) Let y = (y⁻ + y⁺)/2.
  $( c ) Compute g = {\overline{p}}_{i} - {c}_{i} ( y ) - \frac{1}{1 + {β}_{i} {\overline{p}}_{i}} {c}_{i}^{′} ( y ) .$
  (d) if g > θ, let y⁻ = y; if g < θ, let y⁺ = y.
  (e)Repeat Steps (a)-(e) until g = θ. Then xᵢ(θ) = y.
$4. Compute f = \frac{{\sum }_{j ∈ J} {\overline{m}}_{j} {e}^{{\overline{u}}_{j}}}{1 + {\sum }_{j ∈ J} {e}^{{\overline{u}}_{j}}} + \frac{{\sum }_{i ∈ I} \frac{1}{1 + {β}_{i} {\overline{p}}_{i}} {e}^{{x}_{i} ( θ ) + {a}_{i} - {b}_{i} {\overline{p}}_{i} + {β}_{i} {x}_{i} ( θ ) {\overline{p}}_{{i}_{{c}_{i}^{′} ( {x}_{i} ( θ ) )}}}}{1 + {\sum }_{j ∈ J} {e}^{{\overline{u}}_{j}}} .$
5. If f > θ, let θ⁻ = θ; if f < θ, let θ⁺ = θ.
6. Repeat Steps 2-5 until f = θ. The optimal attribute values are given by
xᵢ(θ) obtained in Step 3.
```

### EXAMPLES

Consider a manufacturer with a product cost function c(a, x)=0.1a+1.5e^{1.5x}. The manufacturer currently offers three products in its portfolio, products 1-3, with {a}_{j∈J}=[6, 9, 12], {x}_{j∈J}=[0.6, 0.8, 1.0] and {p}_{j∈J}=[7, 8, 10]. The manufacturer plans to introduce three new products, products 4-6, with attributes {a},_{j∈l}=[6, 9, 12] while still keeping products 1-3 in the product portfolio. The new product prices p̅ᵢ are given in Table 5. Algorithm 2 is applied to optimize attributes xᵢ, i∈l of the new products.

TABLE 5
Optimizing Attributes of New Products

| | | | New Prices | | | Optimal Attributes | | | |
|---|---|---|---|---|---|---|---|---|---|
| Instance | b | β | \tilde{p}₄ | \tilde{p}₅ | \tilde{p}₆ | x₄* | x₅* | x₆* | profit |
| 1 | 1.0 | 0.30 | 6.3 | 7.2 | 9 | 0.18 | 0.32 | 0.59 | 2.71 |
| 2 | 1.0 | 0.30 | 7.7 | 8.8 | 11 | 0.49 | 0.62 | 0.85 | 2.56 |
| 3 | 1.0 | 0.35 | 6.3 | 7.2 | 9 | 0.22 | 0.36 | 0.62 | 2.62 |
| 4 | 1.0 | 0.35 | 7.7 | 8.8 | 11 | 0.51 | 0.64 | 0.87 | 2.55 |
| 5 | 1.0 | 0.40 | 6.3 | 7.2 | 9 | 0.26 | 0.39 | 0.65 | 2.54 |
| 6 | 1.0 | 0.40 | 7.7 | 8.8 | 11 | 0.53 | 0.66 | 0.89 | 2.55 |
| 7 | 1.5 | 0.30 | 6.3 | 7.2 | 9 | 0.22 | 0.36 | 0.61 | 2.51 |
| 8 | 1.5 | 0.30 | 7.7 | 8.8 | 11 | 0.57 | 0.69 | 0.90 | 1.96 |
| 9 | 1.5 | 0.35 | 6.3 | 7.2 | 9 | 0.24 | 0.38 | 0.63 | 2.54 |
| 10 | 1.5 | 0.35 | 7.7 | 8.8 | 11 | 0.58 | 0.69 | 0.91 | 2.10 |
| 11 | 1.5 | 0.40 | 6.3 | 7.2 | 9 | 0.26 | 0.39 | 0.65 | 2.54 |
| 12 | 1.5 | 0.40 | 7.7 | 8.8 | 11 | 0.58 | 0.70 | 0.92 | 2.20 |
| 13 | 2.0 | 0.30 | 6.3 | 7.2 | 9 | 0.58 | 0.67 | 0.85 | 0.27 |
| 14 | 2.0 | 0.30 | 7.7 | 8.8 | 11 | 0.78 | 0.87 | 1.05 | 0.09 |
| 15 | 2.0 | 0.35 | 6.3 | 7.2 | 9 | 0.59 | 0.68 | 0.86 | 0.37 |
| 16 | 2.0 | 0.35 | 7.7 | 8.8 | 11 | 0.80 | 0.89 | 1.06 | 0.14 |
| 17 | 2.0 | 0.40 | 6.3 | 7.2 | 9 | 0.59 | 0.68 | 0.87 | 0.49 |
| 18 | 2.0 | 0.40 | 7.7 | 8.8 | 11 | 0.81 | 0.90 | 1.07 | 0.21 |

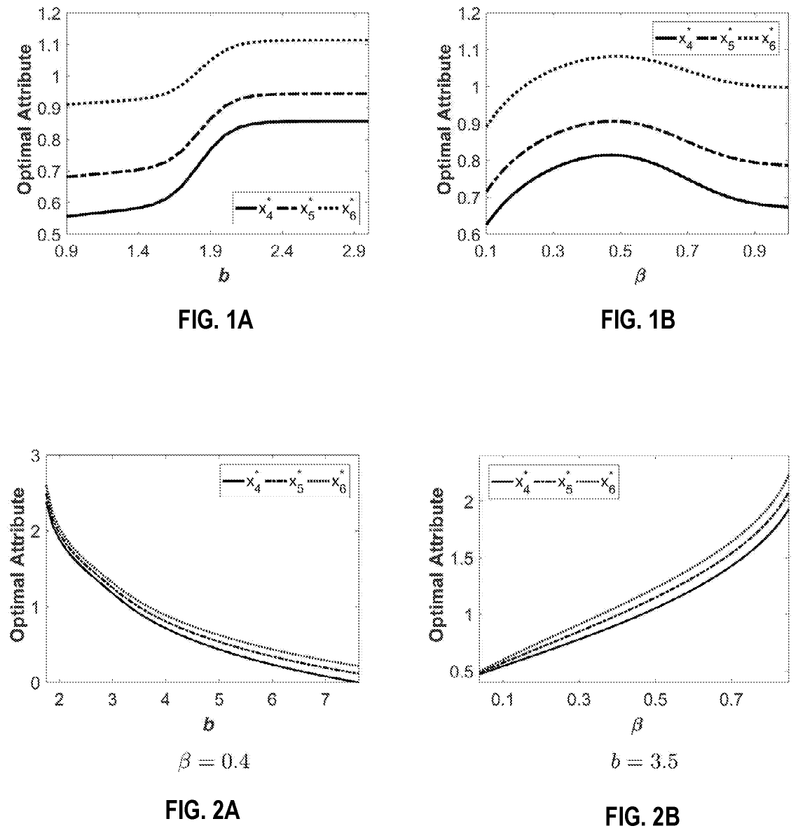

Observations of the attribute optimization results in Table 5 indicate that high-priced products are matched with high attribute values. In addition, the optimal attributes increase with price sensitivity parameter b. While the limited instances in Table 5 seem to indicate that the optimal attributes also increase with β, more extensive numerical experiments, however, show that this trend is not always an increasing one, nor is it necessarily monotonic. FIGS. 1A and 1B illustrate these trends in more detail.

The trend that optimal attributes increase with price sensitivity (FIG. 1A appears counter-intuitive: with higher price sensitivity, customers are less willing to pay high prices; thus it would seem wise not to increase product attributes. However, this dynamic is absent in the attribute optimization problem because prices of the new products are fixed; therefore, as customers become more price sensitive, the manufacturer has to attract them with higher attributes to compete with the no-purchase option. Therefore, the increasing trend in FIG. 1A results from the substitution of attribute for price. As we will demonstrate later, this trend is reversed when attributes and prices are optimized jointly.

The non-monotonic pattern in FIG. 1B suggests that the impact of β on the attribute decision is multifaceted. In particular, recall that the β parameter is the coefficient of the interaction of attribute and price and that it affects the marginal utility of attribute x (see equation (2)). As β increases, customers obtain higher marginal utility of x, creating an incentive for the manufacturer to raise x. On the flip side, as β further increases, the products become more and more competitive relative to no-purchase option and there is diminishing return to gaining additional market share by increasing attribute. And since the manufacturer cannot raise price, the optimal strategy is to shift from prioritizing gains in market share to prioritizing reductions in cost by reducing x values.

### Attribute and Price Optimization

In this section, the joint optimization of product attribute and price is disclosed. For example, the resort hotel considers optimizing both the service package value and the price of each new room offer to maximize the total profit. Let x=(xᵢ)_{i∈l} denote the vector of quality levels for the new products and define Ω={x|0≤xᵢ≤xᵢ⁺, i∈I}.

$${max}_{x , p} π ( x , p ) = {\sum }_{i ∈ I} ( {p}_{i} - {c}_{i} ( {x}_{i} ) ) {q}_{i} ( x , p ) + {\sum }_{j ∈ J} {\overline{m}}_{j} {q}_{j} ( x , p ) .$$

Contrasting this with attribute optimization, which prescribes the optimal attribute values for the new products that differ across products due to differences in price p̅ᵢ and the exogenous attribute aᵢ, the resulting differences in optimal prices and optimal attributes among the new products under joint optimization are solely due to differences in aᵢ. If we interpret the aᵢ value as representing a certain product type, for example, room type in a hotel, type of seats in an airplane (main cabin, business class, first class), or size of a rental car (compact, mid-size, full-size) and the xᵢ value as representing add-on services, the joint attribute-price optimization model helps us optimally set both the level of add-on services and the price for the product to be offered in each type.

Recall that in the hotel example, aᵢ represents customers' utility for a particular room type (i.e., King, Queen or Suite) and xᵢ represents customers' utility for a particular service package (e.g., $50, $80, or $100 resort credit). In general, the value of aᵢ reflects the composite utility of all attributes of product i that are not part of the design decision (i.e., features of the product that are not to be changed), whereas quality xᵢ is the utility from the attribute to be optimized. For example, aᵢ may reflect a certain product type, for example, room type in a hotel, type of seats in an airplane (main cabin, business class, first class), or size of a rental car (compact, mid-size, full-size) and xᵢ may represent add-on services. The joint quality-price optimization model helps to optimally set both the level of add-on services and the price for the product to be offered in each type.

The choice of quality affects product cost. Let cᵢ(xᵢ) be the unit cost of product i∈I at quality xᵢ, which is assumed to be nonnegative. The product cost function may differ across products, reflecting differences in fixed and variable attributes, i.e., cᵢ(xᵢ)=c(aᵢ, xᵢ). For brevity, we denote the cost function with cᵢ(xᵢ) but we emphasize that it is also a function of aᵢ. To ensure that the cost function cᵢ(xᵢ) is well-behaved, we make the following assumption.

Assumption 3. The cost function cᵢ(xᵢ), i∈I is twice differentiable, increasing and convex in xᵢ for all xᵢ∈[0, xᵢ⁺].

It should be noted that the convexity of cᵢ(xᵢ) does not necessitate convexity of the nominal cost curve of a product attribute. Note that xᵢ is a linear utility measure of quality that can be different from its natural or nominal measure. In the smart phone example, suppose that the cost of memory increases linearly with size. Since the x values are generated by taking logarithm, the cost function in terms of x becomes exponential which is convexly increasing. A similar argument holds for the hotel example. Suppose customer utility does not grow linearly with the resort credit amount, but at a lower order of growth (e.g., the rate of a square root function) while the cost of the resort credit grows linearly with the amount. Then the cost function in terms of x becomes convex (e.g., quadratic). In other words, Assumption 3 is satisfied if the cost of the focal attribute is convexly increasing in its linear utility contribution xᵢ or equivalently, the utility of the focal attribute exhibits diminishing return on cost.

Let m=(mᵢ)_{i∈I} where mᵢ=pᵢ−cᵢ(xᵢ). From (5), qᵢ=q₀e^{x}^{ᵢ}^{+a}^{ᵢ}^{-b}^{ᵢ}^{p}^{ᵢ}^{+β}^{ᵢ}^{x}^{ᵢ}^{p}^{ᵢ}=q₀e^{x}^{ᵢ}^{+a}^{ᵢ}^{-(b}^{ᵢ}^{-β}^{ᵢ}^{x}^{ᵢ}^{)p}^{ᵢ}=q₀e^{x}^{ᵢ}^{+a}^{ᵢ}^{-(b}^{ᵢ}^{-β}^{ᵢ}^{x}^{ᵢ}^{)c}^{ᵢ}^{-(b}^{ᵢ}^{-β}^{ᵢ}^{x}^{ᵢ}^{)m}^{ᵢ}

and thus solve mᵢ as a function of x and q:

mᵢ=|xᵢ+aᵢ−(bᵢ−βᵢxᵢ)cᵢ(xᵢ)−log qᵢ+log q₀|/(bᵢ−βᵢxᵢ).

We can express the total profit as

$$\hat{π} ( x , q ) = {\sum }_{i ∈ I} \frac{{q}_{i}}{{b}_{i} - {β}_{i} {x}_{i}} [ {x}_{i} + {a}_{i} - ( {b}_{i} - {β}_{i} {x}_{i} ) {c}_{i} ( {x}_{i} ) - log {q}_{i} + log {q}_{0} ( q ) ] + ( {\sum }_{j ∈ J} {\overline{m}}_{j} {e}^{{\overline{u}}_{j}} ) {q}_{0} ( q ) .$$

Theorem 5. Given \hat{π}(x,q) is concave in the choice probability vector q. The optimal markup is given by

$${m}_{i}^{*} ( x ) = \frac{1}{{b}_{i} - {β}_{i} {x}_{i}} + θ ( x )$$

where θ(x) solves

$$θ = \frac{{\sum }_{i ∈ I} {e}^{{x}_{i} + {a}_{i} - ( {b}_{i} - {β}_{i} {x}_{i} ) {c}_{i} ( {x}_{i} ) - 1 - ( {b}_{i} - {β}_{i} {x}_{i} ) θ} / ( {b}_{i} - {β}_{i} {x}_{i} )}{1 + {\sum }_{j ∈ J} {e}^{{\overline{u}}_{j}}} + \frac{{\sum }_{j ∈ J} {\overline{m}}_{j} {e}^{{\overline{u}}_{j}}}{1 + {\sum }_{j ∈ J} {e}^{{\overline{u}}_{j}}} . \qquad ( 19 )$$

Let \tilde{π}(x)=max_{q} \hat{π}(x, q). The following relationship holds.

Lemma 3. \tilde{π}(x)=θ(x).

Therefore, to maximize \tilde{π}(x), only θ(x) needs to be maximized.

In the special case when βᵢ=0, the optimal solution is unique and given in the following theorem.

Theorem 6 Let x⁺=(x*ᵢ)_{i∈I} and p⁺=(p*ᵢ)_{i∈I} be the optimal solution to the joint quality and price optimization problem. Suppose βᵢ=0. Then the optimal solution is given by

$$\begin{matrix}{x}_{i}^{*} = \{ \begin{matrix}{c}_{i}^{′ - 1} ( \frac{1}{{b}_{i}} ) , & if {c}_{i}^{′ - 1} ( \frac{1}{{b}_{i}} ) ∈ [ 0 , {x}_{i}^{+} ] \\ 0 , & if {c}_{i}^{′ - 1} ( \frac{1}{{b}_{i}} ) < 0 \\ {x}_{i}^{+} , & if {c}_{i}^{′ - 1} ( \frac{1}{{b}_{i}} ) > {x}_{i}^{+}\end{matrix} , i ∈ I . & ( 20 ) \\ {p}_{i}^{*} = {c}_{i} ( {x}_{i}^{*} ) + \frac{1}{{b}_{i}} + {θ}^{*} \\ where {θ}^{*} solves \\ θ = \frac{{\sum }_{i ∈ I} {e}^{{x}_{i}^{*} + {a}_{i} - {b}_{i} {c}_{i} ( {x}_{i}^{*} ) - 1 - {b}_{i} θ} / {b}_{i}}{1 + {\sum }_{j ∈ J} {e}^{{\overline{u}}_{j}}} + {\overline{π}}_{J} . & ( 21 )\end{matrix}$$

Theorem 6 describes the optimal solution of the joint attribute and price optimization in the absence of interaction. Consider a cost function cᵢ(·) that is additively separable in aᵢ and xᵢ. Also, consider a case with symmetric bᵢ, i.e., bᵢ=b for all i∈l. From equations (20) and (21), it must be that x*ᵢ=x*_{i′} and p*ᵢ−cᵢ(x*ᵢ)=p*_{i′}−cᵢ(x*_{i′}) for all i, i′∈l. That is, the optimal prices and attributes are such that all new products have equal markup and equal attribute, as summarized in the following corollary.

Corollary 6. Suppose that the cost function is additively separable in aᵢ and xᵢ, i.e., cᵢ(xᵢ)=cₐ(aᵢ)+cₓ(xᵢ) and that bᵢ=b and βi=0 for all i∈l. Then at optimality, x*ᵢ=x*ᵢ, and m*ᵢ=m*_{i′} for any i, i′∈l.

The result in Corollary 6 lacks realism and is an oversimplification of the effect of attribute and price on customers' utility; however, it serves as a benchmark case for understanding the impact of interaction. Next, we illustrate how the inclusion of a simple attribute and price interaction term leads to a different conclusion by capturing a more realistic relationship between customer preference and product attribute/price.

In general, βᵢ>0 and θ(x) is defined by the implicit function (19). Taking derivatives with respect to xᵢ, and with algebraic transformation, we obtain

$$\frac{\partial θ ( x )}{\partial {x}_{i}} = \frac{{q}_{i}}{{b}_{i} - {β}_{i} {x}_{i}} [ 1 - ( {b}_{i} - {β}_{i} {x}_{i} ) {c}_{i}^{′} ( {x}_{i} ) + {β}_{i} θ + \frac{{β}_{i}}{{b}_{i} - {β}_{i} {x}_{i}} ] . \qquad ( 22 )$$

Define cᵢ⁻=cᵢ(0), which is nonnegative, i.e., the cost to produce a product at its lowest possible xᵢ value is nonnegative, cᵢ⁻≥0. Note that

$$\frac{\partial θ ( 0 )}{\partial {x}_{i}} = ( \frac{{q}_{i}}{{b}_{i}} ) ( 1 - {b}_{i} {c}^{′} ( 0 ) + {β}_{i} ( {c}^{-} + θ ( 0 ) + \frac{1}{{b}_{i}} ) ) .$$

Assumption 4.

$$\frac{\partial θ ( 0 )}{\partial {x}_{i}} > 0 for all i .$$

Assumption 4 recites that when the quality of each product is set to the lowest level 0, the profit increases if the quality of any product increases. This assumption essentially places restrictions on the values of bᵢ's and βᵢ's.

Lemma 4. If Assumption 4 holds, then x*ᵢ∈(0, x⁺)

From Equation (22) and Lemma 4, a necessary condition for optimality is

$${h}_{i} ( x ) := - 1 - {β}_{i} ( θ ( x ) + {c}_{i} ( {x}_{i} ) ) + ( {b}_{i} - {β}_{i} {x}_{i} ) {c}_{i}^{′} ( {x}_{i} ) - \frac{{β}_{i}}{{b}_{i} - {β}_{i} {x}_{i}} = 0 \\ for all i ∈ I , \qquad ( 23 )$$

which can be rewritten as

$$( {b}_{i} - {β}_{i} {x}_{i} ) {c}_{i}^{′} ( {x}_{i} ) - {β}_{i} ( {c}_{i} ( {x}_{i} ) + \frac{1}{{b}_{i} - {β}_{i} {x}_{i}} ) = 1 + {β}_{i} θ \\ for all i ∈ I \qquad ( 24 )$$

If for any given θ, there exists a unique xi such that the above is satisfied, then the joint attribute and price optimization is reduced to a single-variable fixed point solution. If, in addition, the Jacobian of h(x)=(h₁(x), h₂(x), . . . , hₙ(x)) evaluated at x*

$$J ( {x}^{*} ) = [ \begin{matrix}\frac{\partial {h}_{1} ( {x}^{*} )}{\partial {x}_{1}} & … & \frac{\partial {h}_{1} ( {x}^{*} )}{\partial {x}_{n}} \\ ⋮ & ⋱ & ⋮ \\ \frac{\partial {h}_{n} ( {x}^{*} )}{\partial {x}_{1}} & … & \frac{\partial {h}_{n} ( {x}^{*} )}{\partial {x}_{n}}\end{matrix} ]$$

is positive semidefinite for any x* satisfying Equation (23), then x* is a global maximum.

In the following theorem, a sufficient condition is identified for positive semidefinite J(x*) that uses a lower bound on the value

$$\frac{{c}_{i}^{″} ( x )}{{c}_{i}^{′} ( x )}$$

which is a measure of the normalized convexity of the cost function cᵢ(·). The value of

$$\frac{{c}_{i}^{″} ( x )}{{c}_{i}^{′} ( x )}$$

is generally not difficult to evaluate. For example, for polynomial cost functions of the form cᵢ(x)=a+bxⁿ where n>1,

$$\frac{{c}_{i}^{″} ( {x}_{i} )}{{c}_{i}^{′} ( {x}_{i} )} = \frac{n - 1}{x} ;$$

for exponential cost functions of the form

Assumption For any xᵢ∈[0, xᵢ⁺], the cost function cᵢ(·) satisfies

$$\frac{{c}_{i }^{″} ( x )}{{c}_{i}^{′} ( {x}_{i} )} > \frac{3 {β}_{i}}{{b}_{i} - {β}_{i} {x}_{i}} . \qquad 25$$

Assumption 5 ensures that for a given θ, the left side of (17) can only cross 1+βᵢθ from below. Therefore, if a solution to (17) exists, it must be unique. Under Assumption 2, the Jacobian matrix J(x*) is a diagonal matrix with nonnegative diagonal elements (note that

$$\frac{\partial {h}_{i} ( x )}{\partial {x}_{i}} = ( {b}_{i} - {β}_{i} {x}_{i}^{*} ) {c}_{i}^{″} ( {x}_{i}^{*} ) - 2 {β}_{i} {c}_{i}^{′} ( {x}_{i}^{*} ) - {( \frac{{β}_{i}}{{b}_{i} - {β}_{i} {x}_{i}^{*}} )}^{2} > 0 and \\ \frac{\partial {h}_{i} ( x )}{\partial {x}_{j}} = 0 ) ,$$

which is positive semi-definite. This implies global optimality.

Assumption 5 requires that the cost function be “sufficiently” convex. In most realistic scenarios, the interaction effect is small relative to the main effect of price and it can be expected for the fraction

$$\frac{{β}_{i}}{{b}_{i} - {β}_{i} {x}_{i}}$$

to be small. Thus the condition is not as restrictive as it might appear. For polynomial cost functions of the form ci(x)=a+px_{i′} it can be shown that the condition reduces to

$$\frac{n - 1}{3} > \frac{{β}_{i} {x}_{i}^{+}}{{b}_{i} - {β}_{i} {x}_{i}^{+}} ;$$

for exponential cost functions of the form cᵢ(x)=a+be^{ax}, condition (25) reduces to

$$\frac{α}{3} > \frac{{β}_{i}}{{b}_{i} - {β}_{i} {x}_{i}^{+}} .$$

Theorem 7. If Assumption 5 holds, then the optimal profit θ* to the joint quality and price optimization problem is the fixed-point solution to

$$θ = \frac{{\sum }_{i ∈ I} {e}^{{x}_{i} ( θ ) + {a}_{i} - ( {b}_{i} - {β}_{i} {x}_{i} ( θ ) ) {c}_{i} ( {x}_{i} ( θ ) ) - 1 - ( {b}_{i} - {β}_{i} {x}_{i} ( θ ) ) θ} / ( {b}_{i} - {β}_{i} {x}_{i} ( θ ) )}{1 + {\sum }_{j ∈ J} {e}^{{\overline{u}}_{j}}} + {\overline{π}}_{J} . \qquad 26$$

where xₖ(θ) is the unique solution of (17) for any given θ if a solution to (17) exists and xᵢ(θ)=0 or xᵢ⁺ otherwise (specifically, if

$$1 - {b}_{i} {c}_{i}^{′} ( 0 ) + {β}_{i} {c}_{i} ( 0 ) + {β}_{i} θ + \frac{{β}_{i}}{{b}_{i}} < 0 ,$$

then xᵢ(θ)=0; if

$$1 - ( {b}_{i} - {β}_{i} {x}_{i}^{+} ) {c}_{i}^{′} ( {x}_{i}^{+} ) + {β}_{i} {c}_{i} ( {x}_{i}^{+} ) + {β}_{i} θ + \frac{{β}_{i}}{{b}_{i} - {β}_{i} {x}_{i}^{+}} > 0 ,$$

then xᵢ(θ)=xᵢ⁺). In addition, the optimal quality and price values are given by

$$\begin{matrix}{x}_{i}^{*} = {x}_{i} ( {θ}^{*} ) & 27 \\ {p}_{i}^{*} = {c}_{i} ( {x}_{i}^{*} ) + \frac{1}{{b}_{i} - {β}_{i} {x}_{i }^{*}} + {θ}^{*} . & 28\end{matrix}$$

It should be noted that, given additively separable cost functions and symmetric b and β, the optimal quality is not identical across products but varies based on aᵢ values, which can be derived from equation (17). As a result, the optimal markup must also differ across products with different aᵢ values due to equation (28). The following corollary provides a key insight into the implication of the interaction term.

Corollary 7 Suppose Assumption 2 holds. In addition, assume that the cost function is additionally separable a; and xᵢ, i.e., cᵢ(xᵢ)=cₐ(aᵢ)+cₓ(xᵢ) where cₐ(·) is a non-decreasing function, and that bᵢ=b and βᵢ=β for all i∈l. Then, x*ᵢ≥x*_{i′} and *ᵢ≥m*_{i′} if and only if aᵢ≥a_{i′} for any i, i′∈l.

Contrasting this with Corollary 4, the optimal quality levels and markups now differ by aᵢ values and products with a larger aᵢ value is matched with a higher quality as well as a higher markup. In a practical setting, this implies, for example, that the smart phone manufacturer shall design its product line such that a premium model (which corresponds to a high aᵢ value) is matched with a premium storage size as well as a premium price—a commonly-adopted strategy which can now be quantified and optimized with the model developed in this paper.

From (21), it can also be observed that the properties of the optimal prices identified in Corollary 1 for the price optimization problem continue to hold for the joint optimization problem. When price and quality can be determined jointly, lower price sensitivity of a product allows the firm to charge a higher price for the product, and subsequently to also set a higher quality value. Thus the relative magnitude of xᵢ versus other products depends on both βi and bi, as shown in the following corollary.

Corollary 8 Suppose Assumption 2 holds. For any i, i′∈I and i≠i′,

let bᵢ=b_{i′}, βᵢ=β_{i′} and cᵢ( )=c_{i′}(·), then x*ᵢ>x*_{i′} if and only if p*ᵢ>p*_{i′}. (i)

if βᵢ=β_{i′} and cᵢ(·)=c_{i′}(·), then x*ᵢ>x*_{i′} if and only if bᵢ<b_{i′.} (ii)

In addition, we derive the following bounds for θ*.

Corollary 9 Under Assumption 2,

$${\overline{π}}_{J} \leq {θ}^{*} \leq {\overline{π}}_{J} + \frac{{\sum }_{i ∈ I} {e}^{ma x \{ {a}_{i} + \frac{{b}_{i}}{{β}_{i}} - \frac{{b}_{i}^{2}}{{β}_{i}} {c}_{i}^{′} ( 0 ) , {a}_{i} - 1 - {b}_{i} ( {c}_{i} ( 0 ) + {\overline{π}}_{j} ) \}} / {b}_{i}}{1 + {\sum }_{j ∈ J} {e}^{{\overline{u}}_{j}}} .$$

Theorem 7 identifies the fixed-point equation for the optimal solution but does not establish uniqueness of the solution or identify an efficient solution algorithm. Next, it can be shown that the fixed-point solution to (30) is unique and can be obtained with a bisection search. Define

$$g ( θ ) := \frac{{\sum }_{i ∈ I} {e}^{{x}_{i} ( θ ) + {a}_{i} - ( {b}_{i} - {β}_{i} {x}_{i} ( θ ) ) {c}_{i} ( {x}_{i} ( θ ) ) - 1 - ( {b}_{i} - {β}_{i} {x}_{i} ( θ ) ) θ} / ( {b}_{i} - {β}_{i} {x}_{i} ( θ ) )}{1 + {\sum }_{j ∈ J} {e}^{{\overline{u}}_{j}}} .$$

Theorem 8. g(θ) monotonically decreases in θ and equation (30) has a unique fixed-point solution.

As a result of Theorem 8, the solution of equation (30) can be obtained through an efficient bisection search algorithm.

Assumption 6. For any x*ᵢ∈(0, xᵢ⁺) that satisfies (24), the cost function cᵢ(·) satisfies

$$( {b}_{i} - {β}_{i} {x}_{i}^{*} ) {c}_{i}^{″} ( {x}_{i}^{*} ) > 2 {β}_{i} {c}_{i}^{′} ( {x}_{i}^{*} ) + {( \frac{{β}_{i}}{{b}_{i} - {β}_{i} {x}_{i}^{*}} )}^{2} . \qquad 29$$

Assumption 6 implies for a given θ, the left side of Equation (24) can only cross 1+βᵢθ from below. Therefore, if a solution to Equation (24) exists, it must be unique. Under Assumption 6, the Jacobian matrix J(x*) is a diagonal matrix with nonnegative diagonal elements (note that

$$\frac{\partial {h}_{i} ( x )}{\partial {x}_{i}} = ( {b}_{i} - {β}_{i} {x}_{i}^{*} ) {c}_{i}^{″} ( {x}_{i}^{*} ) - 2 {β}_{i} {c}_{i}^{′} ( {x}_{i}^{*} ) - {( \frac{{β}_{i}}{{b}_{i} - {β}_{i} {x}_{i}^{*}} )}^{2} and \\ \frac{\partial {h}_{i} ( x )}{\partial {x}_{j}} = 0 ) ,$$

which is positive semi-definite. This ensures global optimality.
Theorem 9. If Assumptions 4 and 6 hold, then the optimal profit θ* to the joint attribute and price optimization problem is the fixed-point solution to

$$θ = \frac{{\sum }_{i ∈ I} {e}^{{x}_{i} ( θ ) + {a}_{i} - ( {b}_{i} - {β}_{i} {x}_{i} ( θ ) ) {c}_{i} ( {x}_{i} ( θ ) ) - 1 - ( {b}_{i} - {β}_{i} {x}_{i} ( θ ) ) / θ} / ( {b}_{i} - {β}_{i} {x}_{i} ( θ ) )}{1 + {\sum }_{j ∈ J} {e}^{{\overline{u}}_{j}}} + \frac{{\sum }_{j ∈ J} {\overline{m}}_{j} {e}^{{\overline{u}}_{j}}}{1 + {\sum }_{j ∈ J} {e}^{{\overline{u}}_{j}}} . \qquad 30$$

where xᵢ(θ) is the unique solution of Equation (24) for any given θ if a solution to Equation (24) exists and xᵢ(θ)=xᵢ⁺ otherwise. In addition, the optimal attribute and price values are given by

$$\begin{matrix}{x}_{i}^{*} = {x}_{i} ( {θ}^{*} ) & 31 \\ {p}_{i}^{*} = {c}_{i} ( {x}_{i}^{*} ) + \frac{1}{{b}_{i} - {β}_{i} {x}_{i}^{*}} + {θ}^{*} . & 32\end{matrix}$$

It should be remarked that, given additively separable cost functions and symmetric b and β, the optimal attribute is not identical across products but varies based on aᵢ values, which can be derived from equation (24). As a result, the optimal markup must also differ across products with different aᵢ values due to equation (32). The following corollary provides a key insight into the implication of the interaction term.

Corollary 10. Suppose Assumptions 4 and 6 hold. In addition, assume that the cost function is additively separable in aᵢ and xᵢ, i.e., cᵢ(xᵢ)=cₐ(aᵢ)+cₓ(xᵢ) where cₐ(·) is a non-decreasing function, and that bᵢ=b and βᵢ=β for all i∈l. Then x*ᵢ≥x*_{i′} and m*ᵢ≥m*_{i′} if and only if aᵢ≥a_{i′} for any i, i′∈l.

Contrasting this with Corollary 6, the optimal attributes and markups now differ by aᵢ values and products with a larger aᵢ value is matched with a higher attribute as well as a higher markup. In a practical setting, this implies, for example, that the smart phone manufacturer shall design its product line such that a premium model (which corresponds to a high aᵢ value) is matched with a premium storage size as well as a premium price—a commonly-adopted strategy which can now be quantified and optimized with the model developed in this paper.

From Equation (32), it is also observed that the properties of the optimal prices identified in Corollary 1 for the price optimization problem continue to hold for the joint optimization problem. However, the properties of the optimal attribute values given in Corollary 4 are not always retained in the joint optimization problem. In particular, while property (i) in Corollary 4 largely stays true, properties (ii) and (iii) both break down under joint optimization.

Corollary 11. Suppose Assumptions 4 and 6 hold. For any i, i′∈l and i≠i′,

let bᵢ=b_{i′}, βᵢ=βi′ and c′ᵢ(·)=c′_{i′}(·), then x*ᵢ>x*_{i′} if and only if p*ᵢ>p*_{i′}. (i)

if βᵢ=β_{i′} and cᵢ(·)=c_{i′}(·), then x*ᵢ>x*_{i′} if and only if bᵢ<b_{i′}. (ii)

When price and attribute can be determined jointly, lower price sensitivity of a product allows the firm to charge a higher price for the product, and subsequently to also set a higher attribute value. Thus the relative magnitude of xᵢ versus other products becomes dependent on both βᵢ and bᵢ, which explains why properties (ii) and (iii) in Corollary 4 do not carry through to joint optimization.

From equation (24), the optimal solution satisfies

$${θ}^{*} + {c}_{i} ( {x}_{i}^{*} ) = \frac{{b}_{i} - {β}_{i} {x}_{i}^{*}}{{β}_{i}} {c}_{i}^{′} ( {x}_{i}^{*} ) - ( \frac{1}{{β}_{i}} + \frac{1}{{b}_{i} - {β}_{i} {x}_{i}^{*}} ) for all i ∈ I \qquad 33$$

Substitute the above into Equation (26),

$$( 1 + {\sum }_{j ∈ J} {e}^{{\overline{u}}_{j}} ) ( {θ}^{*} - \frac{{\sum }_{j ∈ J} {\overline{m}}_{j} {e}^{{\overline{u}}_{j}}}{1 + {\sum }_{j ∈ J} {e}^{{\overline{u}}_{j}}} ) = {\sum }_{i ∈ I} {e}^{{x}_{i}^{*} + {a}_{i} - 1 - ( {b}_{i} - {β}_{i} {x}_{i}^{*} ) [ \frac{{b}_{i} - {β}_{i} {x}_{i}^{*}}{{β}_{i}} {c}_{i}^{′} ( {x}_{i}^{*} ) - ( \frac{1}{{β}_{i}} + \frac{1}{{b}_{i} - {β}_{i} {x}_{i}^{*}} ) ]} / ( {b}_{i} - {β}_{i} {x}_{i}^{*} ) = {\sum }_{i ∈ I} {e}^{{a}_{i} + \frac{{b}_{i}}{{β}_{i}} - \frac{( {b}_{i} - {β}_{i} {x}_{i}^{*} )}{{β}_{i}} {c}_{i}^{′} ( {x}_{i}^{*} )} / ( {b}_{i} - {β}_{i} {x}_{i}^{*} ) = {\sum }_{i ∈ I} exp ( {a}_{i} + \frac{{b}_{i}}{{β}_{i}} ) exp ( - log ( {b}_{i} - {β}_{i} {x}_{i}^{*} ) - \frac{{( {b}_{i} - {β}_{i} {x}_{i}^{*} )}^{2}}{{β}_{i}} {c}_{i}^{′} ( {x}_{i}^{*} ) ) .$$

It can be shown that under Assumption 6, the term

$$- log ( {b}_{i} - {β}_{i} {x}_{i}^{*} ) - \frac{{( {b}_{i} - {β}_{i} {x}_{i}^{*} )}^{2}}{{β}_{i}} {c}_{i}^{′} ( {x}_{i}^{*} )$$

is strictly decreasing in x*ᵢ. Therefore,

$$( 1 + {\sum }_{j ∈ J} {e}^{{\overline{u}}_{j}} ) ( {θ}^{*} - \frac{{\sum }_{j ∈ J} {\overline{m}}_{j} {e}^{{\overline{u}}_{j}}}{1 + {\sum }_{j ∈ J} {e}^{{\overline{u}}_{j}}} ) \leq {\sum }_{i ∈ I} exp ( {a}_{i} + \frac{{b}_{i}}{{β}_{i}} ) exp ( - log ( {b}_{i} ) - \frac{{b}_{i}^{2}}{{β}_{i}} {c}_{i}^{′} ( 0 ) ) = {\sum }_{i ∈ I} \frac{1}{{b}_{i} } exp ( {a}_{i} + \frac{{b}_{i}}{{β}_{i}} - \frac{{b}_{i}^{2}}{{β}_{i}} {c}_{i}^{′} ( 0 ) ) .$$

Equivalently,

$${θ}^{*} \leq \frac{{\sum }_{i ∈ I} \frac{1}{{b}_{i}} exp ( {a}_{i} + \frac{{b}_{i}}{{β}_{i}} - \frac{{b}_{i}^{2}}{{β}_{i}} {c}_{i}^{′} ( 0 ) )}{1 + {\sum }_{j ∈ J} {e}^{{\overline{u}}_{j}}} + \frac{{\sum }_{j ∈ J} {\overline{m}}_{j} {e}^{{\overline{u}}_{j}}}{1 + {\sum }_{j ∈ J} {e}^{{\overline{u}}_{j}}}$$

Therefore, the following bounds are derived for θ*.

### Corollary 12.

$${\overline{π}}_{j} \leq {θ}^{*} \leq {\overline{π}}_{J} + \frac{{\sum }_{i ∈ I} {e}^{{a}_{i} + m i n \{ {x}_{i}^{+} - 1 , \frac{{b}_{i}}{{β}_{i}} - \frac{{b}_{i}^{2}}{{β}_{i}} {c}_{i}^{′} ( 0 ) \}} / {b}_{i}}{1 + {\sum }_{j ∈ J} {e}^{{\overline{u}}_{j}}} .$$

It is possible that for certain θ values, equation (24) will not have a solution. This could occur in one of the following cases: θ value is unreasonably large, or

$$( {b}_{i} - {β}_{i} {x}_{i} ) {c}_{i}^{′} ( {x}_{i} ) - {β}_{i} ( {c}_{i} ( {x}_{i} ) + \frac{1}{{b}_{i} - {β}_{i} {x}_{i}} )$$

is too small, or both (for example, if

$$( {b}_{i} - {β}_{i} {x}_{i} ) {c}_{i}^{′} ( {x}_{i} ) - {β}_{i} ( {c}_{i} ( {x}_{i} ) + \frac{1}{{b}_{i} - {β}_{i} {x}_{i}} )$$

for all xᵢ∈(0, xᵢ⁺], then (24) is infeasible). In this case, it is easy to see from (22) that

$$\frac{\partial θ ( x )}{\partial {x}_{i} } > 0$$

and the optimal solution is to set xᵢ as large as possible, i.e., at xᵢ⁺. Therefore, in numerical implementation, if infeasibility occurs at a given value of θ, then let xᵢ(θ)=xᵢ⁺.
Theorem 10-. The solution to equation (26) is unique.

The proof of Theorem 10 relies on showing that the right side of (26) strictly decreases in θ. As a result, the solution can be obtained through an efficient bisection search algorithm.

Algorithm 3. (Attribute and Price Optimization)

```
$1. Let {θ}^{-} = \frac{{\sum }_{j ∈ J} {\overline{m}}_{j} {e}^{{\overline{u}}_{j}}}{1 + {\sum }_{j ∈ J} {e}^{{\overline{u}}_{j}}} and {θ}^{+} = \frac{{\sum }_{i ∈ I} {e}^{{x}_{i}^{+} + {a}_{i} - 1 / {b}_{i}}}{1 + {\sum }_{j ∈ J} {e}^{{\overline{u}}_{j}}} + \frac{{\sum }_{j ∈ J} {\overline{m}}_{j} {e}^{{\overline{u}}_{j}}}{1 + {\sum }_{j ∈ J} {e}^{{\overline{u}}_{j}}}$
2. Let θ = (θ⁻ + θ⁺)/2 and solve (24) for xᵢ(θ),
i ∈ I following Steps (a)-(e):
  (a) Let y⁻ = 0 and y⁺ = xᵢ⁺
  (b) Let y = (y⁻ + y⁺)/2.
  $( c ) Compute g = ( {b}_{i} - {β}_{i} {x}_{i} ) {c}_{i}^{′} ( {x}_{i} ) - {β}_{i} ( {c}_{i} ( {x}_{i} ) + \frac{1}{{b}_{i} - {β}_{i} {x}_{i}} ) .$
  (d) if g > 1 + βᵢθ, let y⁻ = y; if g < 1 + βᵢθ, let y⁺ = y.
  (e) Repeat Steps (a)-(e) until g = θ. Then xᵢ(θ) = y.
3. If, for the given θ value, Steps (a)-(e) do not converge, then let θ⁺ = θ
and repeat Step 2. If no solution is found for θ at its lowest value,
then set xᵢ^{*} = xᵢ⁺.
$4. Let {c}_{i} ( {x}_{i} ) = {c}_{i} ( {x}_{i} ( θ ) ) , i ∈ I and compute f = \frac{{\sum }_{i ∈ I} {e}^{{x}_{i} + {a}_{i} - ( {b}_{i} - {β}_{i} {x}_{i} ) {c}_{i} ( {x}_{i} ) - 1 - {( {b}_{i} - {β}_{i} {x}_{i} )}^{θ} / ( {b}_{i} - {β}_{i} {x}_{i} )}}{1 + {\sum }_{j ∈ J} {e}^{{\overline{u}}_{j}}} + \frac{{\sum }_{j ∈ J} {\overline{m}}_{j} {e}^{{\overline{u}}_{j}}}{1 + {\sum }_{j ∈ J} {e}^{{\overline{u}}_{j}}} .$
5. if f > θ, let θ⁻ = θ; if f < θ, let θ⁺ = θ.
6. Repeat Steps 2-4 until f = θ.
```

Lastly, it should be remarked that the condition in Assumption 6 relies on the specification of the cost function cᵢ(xᵢ). Given the cost function form, the condition may be further simplified or, in some settings, used to generate simpler sufficient conditions.

Algorithm 4. (Quality and Price Optimization)

```
$1. Let {θ}^{-} = {\overline{π}}_{J} and {θ}^{+} = {\overline{π}}_{J} + \frac{{\sum }_{i ∈ I} {e}^{max \{ {a}_{i} + \frac{{b}_{i}}{{β}_{i}} - \frac{{b}_{i}^{2}}{{β}_{i}} {c}_{i}^{′} ( 0 ) , {a}_{i} - 1 - {b}_{i} ( {c}_{i} ( 0 ) + {\overline{π}}_{J} ) \}} \text{/} {b}_{i}}{1 + {\sum }_{j ∈ J} {e}^{{\overline{u}}_{j}}} .$
2. Let θ = (θ⁻ + θ⁺)/2 and solve (17) for xᵢ(θ), i ∈ I following
Steps (a)-(e):
  (a) Let y⁻ = 0 and y⁺ = xᵢ⁺.
  (b) Let y = (y⁻ + y⁺)/2.
  $( c ) Compute z = ( {b}_{i} - {β}_{i} {x}_{i} ) {c}_{i}^{′} ( {x}_{i} ) - {β}_{i} ( {c}_{i} ( {x}_{i} ) + \frac{1}{{b}_{i} - {β}_{i} {x}_{i}} ) .$
  (d) if z > 1 + βᵢθ, let y⁻ = y; if z < 1 + βᵢθ, let y⁺ = y.
  (e) Repeat Steps (a)-(e) until z = θ or y⁺ = y⁻. Then xᵢ(θ) = y.
3. If, for the given θ value, Steps (a)-(e) do not converge, then let θ⁺ = θ
and repeat Step 2. If no solution is found for θ at its lowest value,
then set xᵢ^{*} = xᵢ⁺.
$4. Let {c}_{i} ( {x}_{i} ) = {c}_{i} ( {x}_{i} ( θ ) ) , i ∈ I and compute f = \frac{{\sum }_{i ∈ I} {e}^{{x}_{i} + {a}_{i} - ( {b}_{i} - {β}_{i} {x}_{i} ) {c}_{i} ( {x}_{i} ) - 1 - {( {b}_{i} - {β}_{i} {x}_{i} )}^{θ} / ( {b}_{i} - {β}_{i} {x}_{i} )}}{1 + {\sum }_{j ∈ J} {e}^{{\overline{u}}_{j}}} + {\overline{π}}_{J} .$
5. if f > θ, let θ⁻ = θ; if f < θ, let θ⁺ = θ.
6. Repeat Steps 2-4 until f = θ.
```

If, for a given cost function, Assumption 5 is not satisfied, then Algorithm 4 may not be applied. Instead, a special characteristic of the optimality condition in (17) may be noted. That is, given the value of θ, the left side of the equation does not depend on xⱼ, j≠i. This implies that, given θ, a single-dimension search can be used to find all stationary xᵢ values for all i∈I. For any given θ, let xᵢ^{k}(θ), k=1, . . . , K where K>1 be the multiple paths of solutions to equation (17). For any given path (defined by some selection rule when picking a solution to (17) from potentially multiple possibilities), we can show that g(θ) is decreasing in θ by applying Theorem 8 for this generalization. In other words, we have multiple g functions, i.e., g¹(θ), . . . , g^{K}(θ) which are decreasing in θ. The function that yields the largest fixed-point solution to (30) yields the global maximum. Denote this function with g*(θ) and the global maximum with θ*.

Since each g^{k}(θ) function decreases monotonically in θ, it is easy to see that the global maximum must satisfy g^{k}(θ*)≥g^{k}(θ*) for all k=1, . . . , K. Consequently, to locate the global maximum, it suffices to locate the fixed-point solution of θ=gₘₐₓ(θ)+π̅_{J} where gₘₐₓ(θ):=maxₖ g^{k}(θ). Since gmax(θ) must also be decreasing in θ, we can apply bisection search to obtain the optimal value of θ. Therefore, we propose the following algorithm for obtaining the optimal solution when Assumption 5 does not hold or cannot be verified.

Algorithm 5. (Quality and Price Optimization without Assumption 5)

```
$1. Let {θ}^{-} = {\overline{π}}_{J} and {θ}^{+} = {\overline{π}}_{J} + \frac{{\sum }_{i ∈ I} {e}^{{x}_{i}^{+} + {a}_{i} - ( {b}_{i} - {β}_{i} {x}_{i}^{+} ) {c}_{i} ( 0 ) - 1 - ( {b}_{i} - {β}_{i} {x}_{i}^{+} ) {θ}^{-} / ( {b}_{i} - {β}_{i} {x}_{i}^{+} )}}{1 + {\sum }_{j ∈ J} {e}^{{\overline{u}}_{j}}} .$
2. Let θ = (θ⁻ + θ⁺)/2.
  (a) Search in the range of [0,xᵢ⁺] for all values of xᵢ that satisfy (17)
and place them in set Xᵢ. In addition, place 0 and xᵢ⁺ in set Xᵢ,
if they are not already included.
  $( b ) For each x = {( {x}_{i} )}_{i ∈ I} where {x}_{i} ∈ {𝒳}_{i} , compute f ( x ) = \frac{{\sum }_{i ∈ I} {e}^{{x}_{i} + {a}_{i} - ( {b}_{i} - {β}_{i} {x}_{i} ) {c}_{i} ( {x}_{i} ) - 1 - ( {b}_{i} - {β}_{i} {x}_{i} ) θ / ( {b}_{i} - {β}_{i} {x}_{i} )}}{1 + {\sum }_{j ∈ J} {e}^{{\overline{u}}_{j}}} + {\overline{π}}_{J} .$
  (c) Let fₘₐₓ = maxₓ_{ᵢ}_{∈X}_{ᵢ}^{_{,}}_{i∈I} f(x).
3. If fₘₐₓ > θ, then let θ⁻ = θ; if fₘₐₓ < θ, then let θ⁺ = θ.
4. Repeat Steps 2-3 until fₘₐₓ = θ.
```

It should be noted that the upper bound from Corollary 9 holds true only under Assumption 5. Therefore in Algorithm 5 an upper bound can be constructed based solely on xᵢ ∈[0, xᵢ⁺].

### EXAMPLES

Consider a manufacturer with the product cost function c(a, x)=0.1a+0.1e^{1.5x}. The manufacturer has an existing set of products with {aⱼ}_{j∈J}=[0, 5, 10], {x̅ⱼ}_{j∈J}=[0.5, 0.8, 1], {p̅ⱼ}_{j∈J}=[2, 3, 4]. It introduces three new products with {aᵢ}_{i∈l}=[, 5, 10] and jointly optimizes prices and attributes of the new products in the expanded product line. The values of b and β are the same across products and are given in Table 6. Algorithm 3 is applied to optimize both prices and attributes (i.e., pᵢ, xᵢ, i∈l) of the new products and the results are recorded in Table 6.

TABLE 6
Jointly Optimization of Attributes and Prices.

| | | | Optimal Attributes | | | Optimal Prices | | | |
|---|---|---|---|---|---|---|---|---|---|
| Instance | b | β | x₄* | x₅* | x₆* | p₄* | p₅* | p₆* | profit |
| 1 | 3.0 | 0.35 | 1.08 | 1.15 | 1.22 | 2.85 | 3.41 | 3.97 | 1.96 |
| 2 | 3.0 | 0.40 | 1.17 | 1.25 | 1.32 | 3.03 | 3.60 | 4.17 | 2.05 |
| 3 | 3.0 | 0.45 | 1.27 | 1.35 | 1.42 | 3.22 | 3.81 | 4.40 | 2.14 |
| 4 | 3.5 | 0.35 | 0.84 | 0.92 | 0.99 | 2.01 | 2.56 | 3.11 | 1.35 |
| 5 | 3.5 | 0.40 | 0.91 | 0.99 | 1.07 | 2.11 | 2.66 | 3.22 | 1.40 |
| 6 | 3.5 | 0.45 | 0.98 | 1.07 | 1.15 | 2.22 | 2.78 | 3.35 | 1.45 |
| 7 | 4.0 | 0.35 | 0.66 | 0.75 | 0.82 | 1.52 | 2.05 | 2.59 | 0.98 |
| 8 | 4.0 | 0.40 | 0.71 | 0.80 | 0.89 | 1.57 | 2.11 | 2.66 | 1.01 |
| 9 | 4.0 | 0.45 | 0.77 | 0.86 | 0.95 | 1.62 | 2.18 | 2.73 | 1.03 |

Note that products 4-6 are differentiated only by their a, value prior to the optimization. The optimized prices and attributes follow a sequence matching that of a/s, as Corollary 10 implies.

Recall that, under attribute optimization, the optimal attributes increase with price sensitivity b. This trend is reversed with joint optimization as illustrated in Table 6 and FIGS. 2A and 2B: as customers become more price sensitive (equivalently, less willing to pay), the manufacturer lowers prices, which, due to the interaction of attribute and price, leads to lower marginal utility of attribute (equation (2)); this, consequently, drives the manufacturer to reduce attribute.

Now consider the effect of β. Larger β implies higher marginal utility of x, creating incentive to increase attribute; the increased attribute in turn, reduces customers' marginal disutility of price and thus drives up optimal prices, which in turn further increases the marginal utility of x. Due to such a reinforcement effect on the marginal utility, increasing β leads to both higher optimal attributes and higher optimal prices. This stands in contrast to the observation in FIG. 1B for attribute optimization where fixed prices lead to diminishing returns from attribute at higher β values. This discussion reveals a central role that the interaction effect plays in the joint optimization of attributes and prices, i.e., it causes the optimal prices and attributes to move in tandem, and as the interaction intensifies, both move upward.

Joint optimization dominates price or attribute optimization alone and leads to higher profit. We illustrate such improvement with numerical experiments that consider multiple b and β parameter combinations. For each parameter combination, we generate 100 random problem instances by drawing the attribute values of the new products from a uniform distribution on [0, 2] and perform price optimization for each instance. We then compute the percentage profit improvement of joint optimization over price optimization and average over these 100 instances; we also present the average optimal profit underprice optimization and the optimal profit under joint optimization (although we note that the percentage improvement is not based on the average optimal profit). See results in Table 7. Similarly, for each b, β parameter combination, we generate 100 problem instances by randomly selecting the price of each new product within ±15% range of the price for a comparable existing product (i.e., those with the same a value) and perform attribute optimization. Profit improvement with joint optimization is then computed and averaged over these 100 instances; see results in Table 8. As is shown, profit improvement with joint optimization can be substantial.

### Extension: Multi-Dimensional Attribute

Thus far, optimization of a single-dimension attribute has been illustrated and discussed. One can easily envision a practical scenario in which a firm optimizes attribute values across multiple dimensions. For instance, the smartphone manufacturer may differentiate model M2 products in both storage size and screen size or some other potential features. In this section, the model is enhanced to address multi-dimensional attribute.

TABLE 7
Profit Improvement (Joint vs. Price Optimization).

| | | | Average Profit for | Profit for | |
|---|---|---|---|---|---|
| | | | Price | Joint | Average |
| Combination | b | β | Optimization | Optimization | Improvement |
| 1 | 3.5 | 0.35 | 1.23 | 1.35 | 11.1% |
| 2 | 3.5 | 0.40 | 1.28 | 1.40 | 9.8% |
| 3 | 3.5 | 0.45 | 1.34 | 1.45 | 8.9% |
| 4 | 4.5 | 0.35 | 0.60 | 0.74 | 35.8% |
| 5 | 4.5 | 0.40 | 0.62 | 0.76 | 31.8% |
| 6 | 4.5 | 0.45 | 0.65 | 0.77 | 28.2% |
| 7 | 5.5 | 0.35 | 0.31 | 0.43 | 91.0% |
| 8 | 5.5 | 0.40 | 0.32 | 0.44 | 81.0% |
| 9 | 5.5 | 0.45 | 0.33 | 0.45 | 73.2% |

TABLE 8
Profit Improvement (Joint vs. Attribute Optimization).

| | | | Average Profit for | Profit for | |
|---|---|---|---|---|---|
| | | | Attribute | Joint | Average |
| Combination | b | β | Optimization | Optimization | Improvement |
| 1 | 3.5 | 0.35 | 1.07 | 1.35 | 29% |
| 2 | 3.5 | 0.40 | 1.20 | 1.40 | 18% |
| 3 | 3.5 | 0.45 | 1.32 | 1.45 | 11% |
| 4 | 4.0 | 0.35 | 0.36 | 0.98 | 220% |
| 5 | 4.0 | 0.40 | 0.45 | 1.01 | 158% |
| 6 | 4.0 | 0.45 | 0.54 | 1.03 | 112% |
| 7 | 4.5 | 0.35 | 0.08 | 0.74 | 1188% |
| 8 | 4.5 | 0.40 | 0.11 | 0.76 | 883% |
| 9 | 4.5 | 0.45 | 0.14 | 0.77 | 648% |

The utility of product i by a randomly selected customer is

uᵢ=xᵢ(yᵢ)−bᵢpᵢ+βᵢpᵢx(yᵢ)+aᵢ+ϵᵢ

where xᵢ(yᵢ)=yᵢ₁+ . . . +yᵢₘ=yᵢ^{T}1 (1 is an m-dimensional vector of 1's) is the aggregate utility of non-price attributes yᵢ₁, . . . , yᵢₘ. Let cᵢ(yᵢ) denote the unit cost of product i as a function of the vector of non-price attributes yᵢ=(yᵢ₁, yᵢ₂, . . . yᵢₘ), and let y=(yᵢ, . . . , yₘ). Thus, the purchase probabilities are

$$\begin{matrix}{q}_{i} ( y , p ) = \frac{{e}^{{x}_{i} ( {y}_{i} ) + {a}_{i} - {b}_{i} {p}_{i} + {β}_{i} {x}_{i} ( {y}_{i} ) {p}_{i}}}{1 + {\sum }_{j = 1}^{n} {e}^{{x}_{j} ( {y}_{j} ) + {a}_{j} - {b}_{j} {p}_{j} + {β}_{j} {x}_{j} ( {y}_{j} ) {p}_{j}}} and & 34 \\ {q}_{0} ( y , p ) = \frac{1}{1 + {\sum }_{j = 1}^{n} {e}^{{x}_{j} ( {y}_{j} ) + {a}_{j} - {b}_{j} {p}_{j} + {β}_{j} {x}_{j} ( {y}_{j} ) {p}_{j}}} . & 35\end{matrix}$$

The profit function is

$$π = {\sum }_{i ∈ I} ( {\overline{p}}_{i} - {c}_{i} ( {y}_{i} ) ) {q}_{i} ( y , p ) + {\sum }_{j ∈ J} {\overline{m}}_{j} {q}_{j} ( y , p ) .$$

Define

$$\begin{matrix}{\hat{q}}_{i} ( x ) = \frac{{e}^{{x}_{i} + {a}_{i} - {b}_{i} {p}_{i} + {β}_{i} {x}_{i} {p}_{i}}}{1 + {\sum }_{j = 1}^{n} {e}^{{x}_{j} + {a}_{j} - {b}_{j} {p}_{j} + {β}_{j} {x}_{j} {p}_{j}}} & 36 \\ {\hat{q}}_{0} ( x ) = \frac{1}{1 + {\sum }_{j = 1}^{n} {e}^{{x}_{j} + {a}_{j} - {b}_{j} {p}_{j} + {β}_{j} {x}_{j} {p}_{j}}} . & 37\end{matrix}$$

where x=(xᵢ)_{i∈l}. In addition, define

$${\hat{c}}_{i} ( {x}_{i} ) = {min}_{{y}_{i}} \{ {c}_{i} ( {y}_{i} ) \vert {y}_{i}^{′} 1 = {x}_{i} \} .$$

The attribute optimization problem is rewritten as

$${max}_{x} π ( x ) = {\sum }_{i ∈ I} ( {p}_{i} - {\hat{c}}_{i} ( {x}_{i} ) ) {\hat{q}}_{i} ( x ) + {\sum }_{j ∈ J} {\overline{m}}_{j} {\hat{q}}_{j} ( x )$$

and the joint optimization problem as

$${max}_{x , p} π ( x , p ) = {\sum }_{i ∈ I} ( {p}_{i} - {\hat{c}}_{i} ( {x}_{i} ) ) {\hat{q}}_{i} ( x , p ) + {\sum }_{j ∈ J} {\overline{m}}_{j} {\hat{q}}_{j} ( x , p ) .$$

Assumption 7. cᵢ(yᵢ) is convex on Rⁿ and increasing in each dimension, i.e.,

$$\frac{\partial {c}_{i} ( {y}_{i} )}{\partial {y}_{ik}} > 0$$

for i∈l and k=1, . . . , m.
Lemma 5. Suppose Assumption 7 holds. Then is increasing and convex.

The condition in Assumption 7 is satisfied by, for example, additively separable cost functions cᵢ(yᵢ)=cᵢ₁(y₁)+cᵢ₂(y₂)+ . . . +cᵢₘ(yₘ) where cᵢₖ(yₖ), k=1, . . . , m is increasing and convex, as well as non-separable cost functions that are increasing and convex.

From Lemma 5, all results for the single-dimension attribute optimization hold for multi-dimensional attributes under Assumption 7. Hence Algorithm 2 can be adopted for multi-dimension attribute optimization by replacing the cost function with ĉᵢ(·). To compute ĉ′ᵢ(xᵢ) and ĉ″ᵢ(xᵢ), we follow a two-step procedure: (1) Given xᵢ, solve the optimization problem min_{y}_{ᵢ}{cᵢ(yᵢ)|y′ᵢ1=xᵢ} to obtain y*ᵢ. (2) Let ĉ′ᵢ(xᵢ)=λᵢ where λᵢ is the Lagrangian multiplier for the constraint y′ᵢ1−xᵢ and compute

$${\hat{c}}_{i}^{″} ( {x}_{i} ) = {\sum }_{k = 1}^{m} {\sum }_{j = 1}^{m} \frac{{\partial }^{2} {c}_{i} ( {y}_{i}^{*} )}{\partial {y}_{ik} \partial {y}_{ij}} .$$

For joint price-attribute optimization, the condition in Assumption 6 is required for the cost function ĉ(·):

$$( {b}_{i} - {β}_{i} {x}_{i}^{*} ) {\hat{c}}_{i}^{″} ( {x}_{i}^{*} ) > 2 {β}_{i} {\hat{c}}_{i}^{′} ( {x}_{i}^{*} ) + {( \frac{{β}_{i}}{{b}_{i} - {β}_{i} {x}_{i}^{*}} )}^{2} . \qquad 38$$

which translates to

$$( {b}_{i} - {β}_{i} {\sum }_{k = 1}^{m} {y}_{ik}^{*} ) {\sum }_{k = 1}^{m} {\sum }_{j = 1}^{m} \frac{{\partial }^{2} {c}_{i} ( {y}_{i}^{*} )}{\partial {y}_{ik} \partial {y}_{ij}} > 2 {β}_{i} {λ}_{i} + {( \frac{{β}_{i}}{{b}_{i} - {β}_{i} {{\sum }_{k = 1}}^{m} {y}_{ik}^{*}} )}^{2} . \qquad 39$$

in terms of each individual attribute dimension. When condition (38) holds, all theoretical results and algorithm for single attribute joint price-attribute optimization hold in the case of multi-dimensional attribute. In practice, one of the main tasks of product design and engineering is to accurately estimate product cost based on material cost and production technology. With multi-dimensional attribute, the function ĉᵢ(xᵢ) can be viewed as an efficient frontier of product costs and thus can be estimated accordingly. Consequently, verification of (39) reduces to verifying condition (38) directly.

### Effect of Existing Products on Optimal Decision

The impact of existing products on the optimal quality and price decisions of new products is explored, as well as how the impact is modified by the price-quality interaction.

Recall that I is the set of new products and J is the set of existing products. Let π*_{I∪J} denote the total profit of the product line given the set of existing product J and that the price and quality of the new products in I are optimally determined. Let π*_{I} denote the optimal profit with no existing product. Similarly, let (p*_{i|I∪P}, x*_{i|I∪J})_{i∈I} and (p*_{i|I′}, x*_{i|I})_{i∈I} denote the optimal decisions with and without the existing products.

The following corollaries show the effect of existing products on quality/price decisions with and without price-quality interaction. Corollary 13 follows directly from Theorem 9. Corollary 14 follows directly from Theorem 7 and the fact that the left-hand side of equation (17) is increasing in x under Assumption 5.

Corollary 13. Suppose βᵢ=0 for all i∈I. (i) The optimal quality of the new product x*ᵢ, i⊂I is independent of price and quality of any existing product. (ii) If π*_{I∪J}>π*_{I}, then the presence of existing products J causes the prices of new products to increase, i.e., for p_{i|l∪J}⁺>p_{i|I}⁺ for i∈I: otherwise, the opposite holds true.

Corollary 14. Suppose βi>0 for all i∈I and Assumption 5 holds. If π*_{I∪J}>πI_{I}, then the presence of existing products J causes both the quality and prices of new products to increase, i.e., x*_{i|I∪J}>x*_{x|l} and p*_{i|I∪J}>p*_{∈I} for all i∈I; otherwise, the opposite holds true.

The effect of existing products on the optimal price/quality decisions for new products is determined by the relationship between π*_{I∪J} and π*_{J} . From a practical perspective, the existing products J that remain in the offer set at the time new products are introduced are such that π*_{IÅJ}>π*_{I}, i.e., if π*_{I∪J}<π*_{I}, then one or more of the existing products should be dropped from the product line.

Without interaction, assuming that the firm has made the right decision for including products j∈J, the presence of existing products drives up the optimal prices of the new products, but does not affect the optimal quality of the new products. The independence of optimal quality from existing products is a consequence of zero price-quality interaction and is arguably unrealistic in most industry contexts. With interaction, the presence of existing products (assuming that inclusion is a good decision) ought to drive the firm to offer new products positioned higher in both quality and price. This resonates with practical observations. For example, the latest iPhone model X has been introduced in the presence of existing iPhone7 and iPhone8 products, priced at hefty $999, $1149, and $1349 for 64 GB, 256 GB, and 512 GB storage size respectively and a slew of other fancy high-end features (Apple Corporation Website, 2018a). Had iPhone7 and iPhone8 not been included, Apple would probably not have aimed its new products at such extreme high-end target position.

### Conclusion and Discussion

Constantly evolving product lines create challenges for product design. In this paper, we address this complex problem by formulating the pricing and attribute decision problem using a MNL model with attribute-price interaction. We consider three practical variations of the problem: (i) optimize prices of the new products in the presence of existing products in the product line and pre-determined product attributes of the new products, (ii) optimize attributes of the new products in the presence of existing products and pre-determined prices of the new products, and (iii) optimize both prices and attributes of the new products in the presence of existing products. The profit function and the optimal solution are characterized, in particular, how the optimal attributes and/or optimal prices vary across products and with the parameters. Our analysis yields efficient solution algorithms for each problem variation.

An important message that this disclosure brings forth is that the lack of realism in the linear utility of the MNL model and the resulting equal markup and equal attribute properties can be addressed with an interaction term. This interaction term is a simple but powerful extension that is central to understanding the attribute and price decision in product line design. With the interaction effect, the optimal attribute and markup vary across products even under identical price sensitivity and cost function. Illustrative examples add further insights on how the optimal solution is affected by coefficients of the utility model and how the joint optimization improves the firm's profit beyond what is accomplished by price or attribute optimization alone.

In practice, a mixed optimization in which price optimization and attribute optimization may be performed on different sets of products is likely. For example, the manufacturer may decide to optimize prices of both new and old products but only optimize attributes of the new products. This scenario is not modeled in the current three variations; however, our model can be extended to consider such a scenario. To see this, note that given attributes, price optimization yields a unique price solution. That is, given xᵢ there exists θ(x) that solves

$$θ = {\sum }_{i ∈ I} {e}^{{x}_{i} + {a}_{i} - ( {b}_{i} - {β}_{i} {x}_{i} ) ( θ + {c}_{i} ( {x}_{i} ) ) - 1} / ( {b}_{i} - {β}_{i} {x}_{i} ) + {\sum }_{j ∈ J} {e}^{{\overline{x}}_{j} + {a}_{j} - ( {b}_{j} - {β}_{j} {\overline{x}}_{j} ) ( θ + {c}_{j} ) - 1} / ( {b}_{j} - {β}_{j} {\overline{x}}_{j} ) . \qquad 40$$

Thus Theorem 5 holds by replacing equation (19) with (36). We can subsequently show that under Assumptions 4 and 6, the optimal solution of the joint price-attribute decision is unique and given by the fixed point equation

$$θ = {\sum }_{i ∈ I} {e}^{{x}_{i} ( θ ) + {a}_{i} - ( {b}_{i} - {β}_{i} {x}_{i} ( θ ) ) ( θ + {c}_{i} ( {x}_{i} ( θ ) ) ) - 1} / ( {b}_{i} - {β}_{i} {x}_{i} ( θ ) ) + {\sum }_{j ∈ J} {e}^{{\overline{x}}_{j} + {a}_{j} - ( {b}_{j} - {β}_{j} {\overline{x}}_{j} ) ( θ + {c}_{j} ) - 1} / ( {b}_{j} - {β}_{j} {\overline{x}}_{j} ) .$$

Hence Algorithm 3 holds for the mixed optimization with the above adjustment. Lastly, we remark that, although we model the fixed attribute aᵢ without an interaction with price, it should be clear that explicitly adding the interaction of aᵢ with pᵢ results in the same problem formulation. In sum, the model and methods in this disclosure apply broadly to practical decision scenarios.

### Computing Device

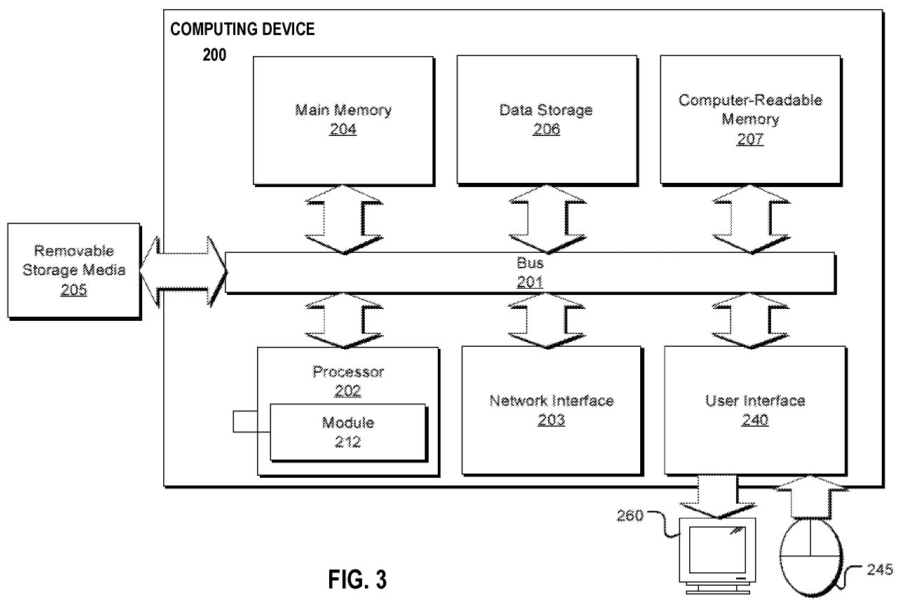

FIG. 3 illustrates an example of a suitable computing device 200 which may be used to implement various aspects of a pricing model and one or more corresponding solution algorithms to generate optimized pricing, as described herein. More particularly, in some embodiments, aspects of the described optimizing pricing model may be translated to software or machine-level code, which may be installed to and/or executed by the computing device 200 such that the computing device 200 is configured to generate optimized pricing according to the methods and functions described herein. It is contemplated that the computing device 200 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 200 may include various hardware components, such as a processor 202, a main memory 204 (e.g., a system memory), and a system bus 201 that couples various components of the computing device 200 to the processor 202. The system bus 201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 200 may further include a variety of memory devices and computer-readable media 207 that includes removable/non-removable media and volatile/nonvolatile media and/or tangible media, but excludes transitory propagated signals. Computer-readable media 207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the general purpose computing device. Communication media includes computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 204 includes computer storage media in the form of volatile/nonvolatile memory such as read only memory (ROM) and random access memory (RAM). A basic input/output system (BIOS), containing the basic routines that help to transfer information between elements within the general purpose computing device (e.g., during start-up) is typically stored in ROM. RAM typically contains data and/or program modules that are immediately accessible to and/or presently being operated on by processor 202. Further, data storage 206 stores an operating system, application programs, and other program modules and program data.

The data storage 206 may also include other removable/non-removable, volatile/nonvolatile computer storage media. For example, data storage 206 may be: a hard disk drive that reads from or writes to non-removable, nonvolatile magnetic media; a magnetic disk drive that reads from or writes to a removable, nonvolatile magnetic disk; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules and other data for the general purpose computing device 200.

A user may enter commands and information through a user interface 240 (displayed via a monitor 260) by engaging input devices 245 such as a tablet, electronic digitizer, a microphone, keyboard, and/or pointing device, commonly referred to as mouse, trackball or touch pad. Other input devices 245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 245 are in operative connection with the processor 202 and may be coupled to the system bus 201, but may be connected by other interface and bus structures, such as a parallel port, game port or a universal serial bus (USB). A monitor 260 or other type of display device is also connected to the system bus 201. The monitor 260 may also be integrated with a touch-screen panel or the like.

The computing device 200 may be implemented in a networked or cloud-computing environment using logical connections of a network interface 203 to one or more remote devices, such as a remote computer. The remote computer may be a personal computer, a server, a router, a network PC, a peer device or other common network node, and typically includes many or all of the elements described above relative to the general purpose computing device. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 200 may be connected to a public and/or private network through the network interface 203. In such embodiments, a modem or other means for establishing communications over the network is connected to the system bus 201 via the network interface 203 or other appropriate mechanism. A wireless networking component including an interface and antenna may be coupled through a suitable device such as an access point or peer computer to a network. In a networked environment, program modules depicted relative to the general purpose computing device, or portions thereof, may be stored in the remote memory storage device.

### Computing System

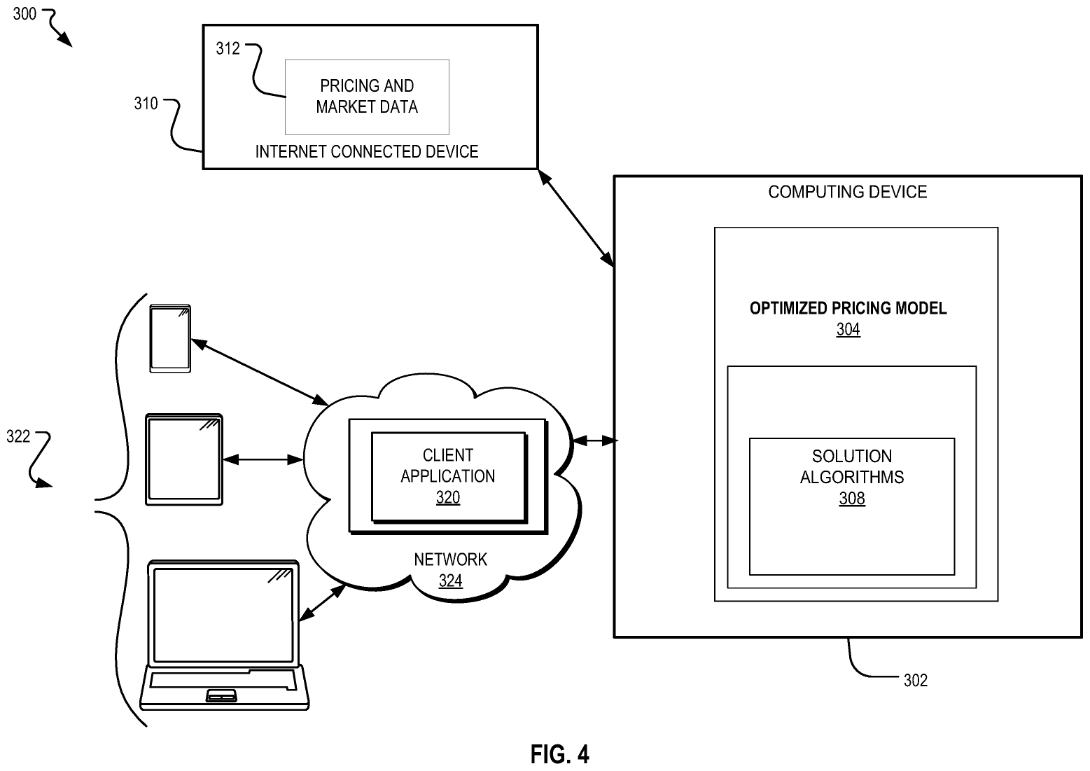

Referring to FIG. 4, in some embodiments a computer-implemented framework for enterprise pricing as described herein may be implemented at least in part by way of a computing system 300. In general, the computing system 300 may include a plurality of components, and may include at least one computing device 302, which may be equipped with at least one or more of the features of the computing device 200 described herein. As indicated, the computing device 302 may be configured to implement an optimized pricing model 304 which may include one or more of a solution algorithm 306 for generating optimized pricing as described herein. Aspects of the optimized pricing model 304 may be implemented as code and/or machine-executable instructions executable by the computing device 302 that may represent one or more of a procedure, a function, a subprogram, a program, a routine, a subroutine, a module, a software package, a class, or any combination of instructions, data structures, or program statements related to the above model/s and methods. A code segment of the optimized pricing model 304 may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In other words, aspects of the optimized pricing model 304 may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium, and a processor(s) associated with the computing device 302 may perform the tasks defined by the code; such that the computing device 302 is configured via the aforementioned hardware and software components to perform the optimized price functionality described herein.

As further shown, the system 300 may include at least one internet connected device 310 in operable communication with the computing device 302. In some embodiments, the internet connected device 310 may provide pricing and market data 312 to the computing device 302 for training purposes or real world pricing optimization. The internet connected device 310 may include any electronic device capable of accessing/tracking pricing and market data such over a predetermined period of time. In addition, the system 300 may include a client application 320 which may be configured to provide aspects of the optimized pricing model 304 to any number of client devices 322 via a network 324, such as the Internet, a local area network, a wide area network, a cloud environment, and the like.

Example embodiments described herein may be implemented at least in part in electronic circuitry; in computer hardware executing firmware and/or software instructions; and/or in combinations thereof. Example embodiments also may be implemented using a computer program product (e.g., a computer program tangibly or non-transitorily embodied in a machine-readable medium and including instructions for execution by, or to control the operation of, a data processing apparatus, such as, for example, one or more programmable processors or computers). A computer program may be written in any form of programming language, including compiled or interpreted languages, and may be deployed in any form, including as a stand-alone program or as a subroutine or other unit suitable for use in a computing environment. Also, a computer program can be deployed to be executed on one computer, or to be executed on multiple computers at one site or distributed across multiple sites and interconnected by a communication network.

Certain embodiments may be described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method of computer implemented enterprise pricing, comprising:
utilizing a processor in communication with a tangible storage medium storing instructions that are executed by the processor to perform operations comprising:
defining a price optimization function taking as input at least a vector of prices of a set of new products;
redefining a term for a profit in the price optimization function as a function of choice probabilities of the set of new products;
generating a value of concavity of the profit; and
employing a bisection search algorithm to solve for an optimal price and an optimal profit of the set of new products by:
generating an upper limit of the price optimization function,
generating a lower limit of the price optimization function;
averaging across the upper limit and the lower limit to find an average of the upper limit and the lower limit, and
inputting the average of the upper limit and the lower limit into the price optimization function.

2. The method of claim 1, wherein an attribute value of the set of new products is predefined.

3. The method of claim 1, wherein a value of marginal utility of an attribute value of the set of new products depends upon a price of the set of new products.

4. The method of claim 1, wherein a value of marginal utility of the price of the set of new products depends upon an attribute value of the set of new products.

5. A method of computer implemented enterprise pricing, comprising:
utilizing a processor in communication with a tangible storage medium storing instructions that are executed by the processor to perform operations comprising:
defining a first value of customer utility reflecting a composite utility value of a product;
defining a second value of customer utility reflecting an attribute;
defining a product cost function inputting at least the first value of utility;
defining an attribute optimization problem inputting at least a vector of attribute values for a new product, the product cost function, and the second value of customer utility and outputting a maximum value of an utility function; and
employing a bisection search algorithm to solve the attribute optimization problem by:
generating a first upper limit of the attribute optimization problem,
generating a first lower limit of the attribute optimization problem,
averaging across the first upper limit and the first lower limit to find a first average of the first upper limit and the first lower limit,
inputting the average of the first upper limit and the first lower limit into the utility function,
generating a second upper limit of the utility function,
generating a second lower limit of the utility function,
averaging across the second upper limit and the second lower limit to find a second average of the second upper limit and the second lower limit, and
inputting the first average and the second average into the attribute optimization problem.

6. The method of claim 5, wherein a price value of the product is exogenous.

7. The method of claim 5, wherein a value of marginal utility of an attribute value of the product depends upon the price value of the product.

8. The method of claim 5, wherein a value of marginal utility of the price value of the product depends upon the attribute value of the product.

9. The method of claim 5, wherein an attribute value of the product increases with a value of price sensitivity of the product.

10. A method of modeling interaction between a product attribute and a product price, comprising;
utilizing a processor in communication with a tangible storage medium storing instructions that are executed by the processor to perform operations comprising:
employing a multinomial logit model to generate a value of purchase probability by:
defining a utility function inputting an attribute value, a price of a product, an observable independent utility term, and a randomly generated noise term;
redefining the utility function into a first form considering a marginal disutility of the price of the product;
redefining the utility function into a second form considering a marginal utility of the attribute value;
defining a set of existing products and a set of new products;
setting a no-purchase option having a utility value of zero; and
generating a purchase probability value of the set of new products, a purchase probability of the set of existing products, and a no-purchase probability each as functions of the utility function, the first form of the utility function, and the second form of the utility function.

11. The method of claim 10, wherein the randomly generated noise term is a Gumbel random variable.

12. The method of claim 10, wherein the marginal disutility decreases as the attribute value decreases.

13. The method of claim 10, wherein the marginal utility increases as the price increases.

14. The method of claim 10, further comprising employing the multinomial logit model to model demand of the product.

15. The method of claim 10, further comprising employing the multinomial logit model to optimize the price of the product and the attribute value of the product.

16. The method of claim 10, wherein the marginal utility of the attribute value depends upon the price.

17. The method of claim 10, wherein the marginal utility of the price depends upon the attribute value.

18. The method of claim 10, wherein the attribute value is exogenous.

19. The method of claim 10, wherein the attribute value decreases with a value of price sensitivity.

20. The method of claim 10, wherein the attribute value is multi-dimensional.
